(19) United States
(12) Patent Application Publication
(10) Pub. No.: US 2012/0176085 A1
(43) Pub. Date: Jul. 12, 2012

(54) REMOTE WIRELESS DRIVING CHARGER

(75) Inventors: Jun IIDA, Kyoto (JP); Kimitake UTSUNOMIYA, Tokyo (JP)

(73) Assignee: ROHM CO., LTD., Kyoto (JP)

(21) Appl. No.: 13/343,139

(22) Filed: Jan. 4, 2012

(30) Foreign Application Priority Data
Jan. 4, 2011 (JP) 2011-000209

(51) Int. Cl. H02J 7/00

(52) U.S. Cl. 320/108

(57) ABSTRACT

A remote wireless driving charger includes: a transmitter; a primary side resonance capacitor connected to the transmitter; a primary coil which is connected to the primary side resonance capacitor and is tuned to be resonant with the primary side resonance capacitor in a predetermined power carrier frequency band; a secondary coil embedded in a portable device; and a secondary side resonance capacitor which is connected to the secondary coil and is tuned to be resonant with the secondary coil in the predetermined power carrier frequency band. Radioactive inductance components as micro loops of the primary coil and the secondary coil are cancelled out by the non-radioactive primary side resonance capacitor and secondary side resonance capacitor through an electromagnetic coupling between the primary coil and the secondary coil, and the portable device is remotely and wirelessly charged.

### CROSS-REFERENCE TO RELATED APPLICATIONS

This application is based upon and claims the benefit of priority from Japan Patent Application No. 2011-000209, filed on Jan. 4, 2011, the entire contents of which are incorporated herein by reference.

### TECHNICAL FIELD

The present disclosure relates to a remote wireless driving charger, and more particularly, to a remote wireless driving charger using a carrier of a shortwave to UHF band.

### BACKGROUND

As a power supply system for supplying power to a mobile electronic apparatus such as a mobile phone, a laptop computer, a digital camera, an electronic toy or the like, there is known a power supply system that can supply power to different kinds of electronic apparatuses by a single power transmitter. The conventional power supply system includes a power transmitter and a portable telephone set. The power transmitter includes a primary coil and a primary circuit that provides a pulse voltage, which is generated by switching a DC voltage obtained by rectifying commercial power, to the primary coil. The portable telephone set includes a secondary coil magnetically coupled to the primary coil and a secondary circuit that rectifies an induction voltage induced to the secondary coil and filters ripples thereof.

A schematic circuit configuration of a conventional charging AC adaptor with a dedicated cable connection, which uses an iron core insulating transformer (also called a magnetic core transformer), is shown in FIG. 19A and a schematic circuit configuration of a conventional charging AC adaptor of a chopper type charger using a high frequency transformer with a ferrite core is shown in FIG. 19B.

As shown in FIG. 19A, a conventional charging AC adaptor 24a includes a magnetic core transformer 13 connected to an AC terminal of, for example, AC 100 to 115 V or AC 200 to 240 V, a diode bridge 2 connected to a secondary side of the magnetic core transformer 13, a voltage stabilization circuit 3 connected to the diode bridge 2, and a DC output terminal 16 connected to the voltage stabilization circuit 3. The charging AC adaptor 24a may be connected to a portable device such as a notebook computer 20 or the like including, for example, a charging profile integrated circuit (IC) 14 via a dedicated cable 8a. An LED indicator 19 included in the charging AC adaptors 24a is only turned on during AC connection.

As shown in FIG. 19B, an AC adaptor 24b includes a diode bridge 2 connected to an AC terminal of, for example, AC 100 to 115 V or AC 200 to 240 V and a chopper circuit 5 connected to the diode bridge 2 and having a chopper frequency fc. A ferrite core high frequency transformer 11 is connected to the chopper circuit 5, and a diode bridge 6 is connected to a secondary side of the ferrite core high frequency transformer 11. A voltage detection circuit 9 is connected to the diode bridge 6 and operates based on a band gap voltage reference. A DC output terminal 16 is connected to the voltage detection circuit 9, and a photo-coupler 7 is connected between the voltage detection circuit 9 and the chopper circuit 5 and returns a voltage detection error signal of the voltage detection circuit 9 to the chopper circuit 5. The charging AC adaptor 24b may be connected to a portable device such as a mobile phone 22 or the like including, for example, a charging profile IC 14 via a dedicated connector 8b. The conventional chopper type charging AC adaptor 24b is an accessory part of the portable device, which is typically supplied as a package and cannot be used anymore when the portable device's life has ended.

In the conventional chopper type charging AC adaptor 24b, the ferrite core high frequency transformer 11 may become more compact with an increase in the chopper frequency fc. On the other hand, a power loss of a transistor, which is arranged within the chopper circuit 5 and performs a switching operation with the chopper frequency, is increased with an increase in the chopper frequency fc. Accordingly, the conventional chopper type charging AC adaptor 24b has a trade-off between the compactness of the ferrite core high frequency transformer 11 and the power loss of the transistor performing the switching operation with the chopper frequency, and therefore it was designed to provide an optimal trade-off.

In a conventional connection charging method, as shown in FIGS. 19A and 19B, a voltage of about DC 5 V, obtained by rectifying a voltage of about AC 100 to 240 V through the step-down transformer, is supplied to the portable device via the dedicated cable 8a or the dedicated connector 8b. A 3.5 V lithium ion battery of the portable device is charged through the charging profile IC 14 having a fast charging profile. This method has the following limits. There is a need to connect the portable device and the charging AC adaptor by a cable or the like. Resource savings and a reduction of production cost are limited. Efficiency improvements and a reduction of standby power (a reduction of an excitation current of a transformer during non-charging) are limited. Further, improvement in reliability and safety is limited due to excessive volume density of the charging battery, firing and explosion accidents, and frequent failures of the AC adaptor.

A non-contact power feeding system has also been proposed.

For example, as shown in FIG. 20, a conventional non-contact charger has a structure where a magnetic core high frequency transformer is divided into two parts which face each other as close as possible. This charger aims to secure a magnetic coupling coefficient of 0.8 or more by approaching a closed magnetic circuit. As shown in FIG. 20, in a divided magnetic core, a primary coil 150a is wound on a magnetic core 130a at a source side and a secondary coil 150b is wound in a magnetic core 130b at a drain side. Typically, when the magnetic core 130a at the source side and the magnetic core 130b at the drain side face each other as close as possible, a magnetic coupling coefficient of the conventional adhesion non-contact charging is about 80% and the remaining 20% corresponds to a leakage magnetic field between the magnetic core 130a at the source side and the magnetic core 130b at the drain side, as shown in FIG. 20.

Such a conventional non-contact charger attempts to reduce a leakage magnetic flux by arranging as many closed magnetic circuits as possible. A transformer design based on this concept is based on the premise that the magnetic coupling coefficient between the primary coil and the secondary coil overshadows power transmission efficiency. Accordingly, if the magnetic coupling coefficient provides a loose coupling, the power transmission efficiency is significantly reduced.

In addition, since this non-contact charger employs induction heating (IH), foreign objects are likely to be overheated. To avoid this risk, there is a need to add an interactive communication function or detection and identification function of a target and foreign objects. Also, it is necessary to consider disturbance due to a magnetic flux crossing parts, a substrate and a chassis in a portable device.

As examples of supplying power in the related art, FIG. 21A shows an example of contact charging, FIG. 21B shows an example of adhesion non-contact charging, and FIG. 21C shows an example of wireless transmission charging with a strong resonant magnetic coupling.

The contact charging shown in FIG. 21A is one example of a connection of a mobile phone 22 to a charging base 240 of a conventional charging AC adaptor through a connector. The non-contact charging shown in FIG. 21B is one example of the mounting of a mobile phone 22 on a charging base 240 of an low-priced adhesion non-contact charger. The wireless power transmission charging shown in FIG. 21C is one example of an arrangement of a primary coil 110 and a secondary coil 120 based on experiments performed at the Massachusetts Institute of Technology (MIT), where the primary coil 110 and the secondary coil 120, each having a radius of about 60 cm, face each other at a distance R=2.1 m (7 feet) to achieve transmission efficiency of 40% through a strong resonant magnetic coupling. The volume of copper used is 270 cc for one side.

As a conventional non-contact power transmission technique, the technique for facing the primary coil 110 and the secondary coil 120 with each other as close as possible in a non-contact manner using the charging base 240, as shown in FIG. 21B, differs insignificantly from the power transmission technique using the charging base 240 of the conventional charging AC adaptor, as shown in FIG. 21A.

In addition, as shown in FIG. 21C, although wireless power transmission experiments were conducted, it is difficult to put the methods used in these experiments to practical use in the future from a logical standpoint.

An adhesion non-contact charging scheme is designed in such a manner that transmission efficiency of an adhesion non-contact transformer is overshadowed by a magnetic coupling coefficient k of the electromagnetic coupling, and thus, the efficiency rapidly deteriorates if the transformer is displaced by a distance of several cm from the charging base. Further, although placement of a mobile phone on the charging base provides no change with a contact portion due to an adhesion non-contact charging scheme, product costs of this scheme are increased.

### SUMMARY

The present disclosure provides some embodiments of a remote wireless driving charger using a shortwave to UHF band carrier, which is capable of wirelessly and remotely charging and driving portable devices with an efficiency of 50% or more without being affected by foreign objects even if the portable devices lie at any position in a solid angle.

According to one embodiment of the present disclosure, there is provided a remote wireless driving charger including a transmitter, a primary side resonance capacitor, a primary coil, a secondary coil and a secondary side resonance capacitor. The primary side resonance capacitor is connected to the transmitter. The primary coil is connected to the primary side resonance capacitor and is tuned to be resonant with the primary side resonance capacitor in a predetermined power carrier frequency band. The secondary coil is embedded in a portable device. The secondary side resonance capacitor is connected to the secondary coil and is tuned to be resonant with the secondary coil in the predetermined power carrier frequency band. In the remote wireless driving charger according to the present embodiment of the present disclosure, the radioactive inductance components as micro loops of the primary coil and the secondary coil are cancelled out by the non-radioactive primary side resonance capacitor and secondary side resonance capacitor through an electromagnetic coupling between the primary coil and the secondary coil, and the portable device is remotely and wirelessly charged.

### BRIEF DESCRIPTION OF THE DRAWINGS

FIG. 1 is a schematic bird's-eye view showing an application of a remote wireless driving charger according to an embodiment of the present disclosure to a mobile phone.

FIG. 2 is a schematic circuit diagram of the remote wireless driving charger according to an embodiment of the present disclosure.

FIG. 3 is a view showing an example of a primary coil and a secondary coil which is connected to or embedded in a mobile phone in the remote wireless driving charger according to an embodiment of the present disclosure.

FIG. 4 is a three-dimensional coordinate system representation for explaining near field/far field radiation of a micro loop A.

FIG. 5 is a schematic view for explaining an effect of remote wireless coupling between a secondary coil placed co-axially, a secondary coil placed on a co-plane, and a secondary coil placed randomly with respect to a primary coil in the remote wireless driving charger according to an embodiment of the present disclosure.

FIG. 6 is an equivalent circuit diagram of wireless power transmission in consideration of radiation loss resistance and copper loss resistance in the remote wireless driving charger according to an embodiment of the present disclosure.

FIG. 7 is a view showing a relationship between a distance R and a power transmission efficiency η in co-axial arrangement for mL=0.7 to 1.4 under the presumption that two coil radiation loss resistances are independent of each other under the condition of rc<<rr (copper loss is negligibly smaller than radiation loss) in the remote wireless driving charger according to an embodiment of the present disclosure.

FIG. 8 is a view showing a relationship between a distance R and a power transmission efficiency η in co-planar arrangement for mL=0.7 to 1.4 under the presumption that two coil radiation loss resistances are independent of each other under the condition of rc<<rr (copper loss is negligibly smaller than radiation loss) in the remote wireless driving charger according to an embodiment of the present disclosure.

FIG. 9 is a vector representation of a magnetic field H induced in a secondary coil by a micro loop A at any position separated by a distance R from the primary coil in the remote wireless driving charger according to an embodiment of the present disclosure.

FIG. 10 is a schematic bird's-eye view for explaining omnidirectional charging from the primary coil in the remote wireless driving charger according to an embodiment of the present disclosure.

FIG. 11 is a schematic view for explaining the effect of a foreign object on wireless power transmission in the remote wireless driving charger according to an embodiment of the present disclosure.

FIG. 12 is a schematic view for explaining the effect of a human body on wireless power transmission in the remote wireless driving charger according to an embodiment of the present disclosure.

FIG. 13 is a schematic view for explaining a mobile phone remotely and wirelessly charged by the remote wireless driving charger according to an embodiment of the present disclosure and a secondary coil embedded in the mobile phone.

FIGS. 14A and 14B are views for explaining the operation principle of a micro loop antenna having a large Q and an equivalent circuit diagram thereof, respectively.

FIG. 15 is a view showing an example of a charging profile of a lithium ion battery embedded in a portable device remotely and wirelessly charged by the remote wireless driving charger according to an embodiment of the present disclosure.

FIGS. 16A and 16B are equivalent circuit diagrams of wireless power transmission in a copper loss limit region (rc>>rr) in the remote wireless driving charger according to an embodiment of the present disclosure and an equivalent circuit diagram of a portable device, respectively.

FIG. 17 is a view showing a relationship between a distance R and a power transmission efficiency η in co-axial arrangement in a copper loss limit region (rc>>rr) in the remote wireless driving charger according to an embodiment of the present disclosure

FIGS. 18A to 18D show common portable device charging techniques, 18A being a schematic explanatory view of an embodiment capable of wirelessly charging and driving a mobile phone and a notebook computer omnidirectionally within a spherical surface having a radius of Ro using the remote wireless driving charger according to an embodiment, 18B and 18C being schematic explanatory views of a comparative example capable of wirelessly charging and driving a mobile phone and a notebook computer in a near field using a near field wireless charging AC adaptor, and 18D being a schematic explanatory view of a comparative example capable of charging and driving a mobile phone and a notebook computer through a cord connection using a dedicated cable, a dedicated connector or the like.

FIGS. 19A and 19B are schematic circuit diagrams of a conventional dedicated cable connection AC charging adaptor using an iron core insulating transformer, which is applied to a notebook computer, and a schematic circuit diagram of a conventional chopper type charger using a ferrite core high frequency transformer, which is applied to a portable device, respectively.

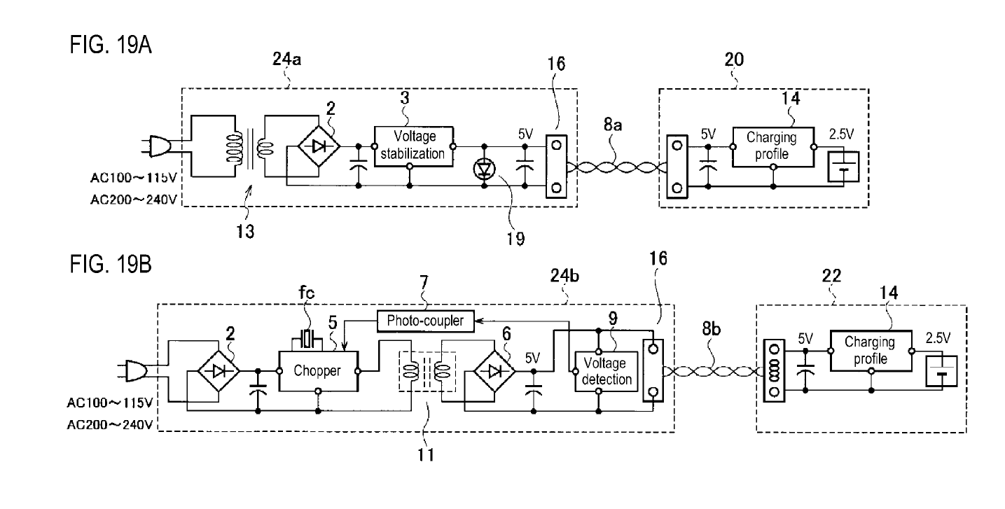

FIG. 20 is a schematic structural view of a high frequency transformer applied to a conventional non-contact charger.

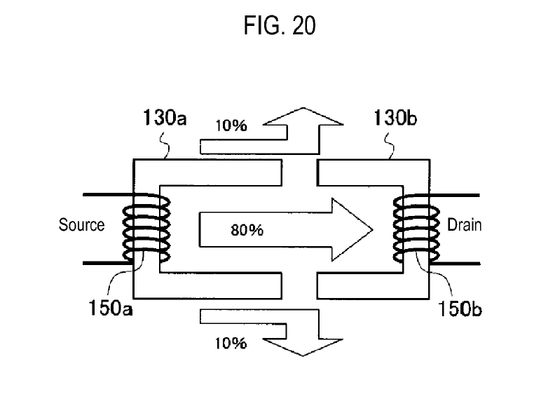

FIGS. 21A to 21C show conventional power supplying cases, FIG. 21A showing an example of contact charging, FIG. 21B showing an example of adhesion non-contact charging, and FIG. 21C showing an example of an arrangement of a primary coil and a secondary coil with strong resonant magnetic coupling in a copper loss limit range, which corresponds to the MIT experiment.

### DETAILED DESCRIPTION

Embodiments of the present disclosure will now be described with reference to the drawings. Throughout the drawings, the same or similar elements are denoted by the same or similar reference numerals. It should be noted that figures of the drawings are just schematic and are different in reality. It should be also understood that the figures include portions having different numerical relationships and ratios.

The following embodiments illustrate apparatuses and methods embodying the principles of the present disclosure and are not intended to be limited to arrangement and so on of elements which are described in the specification. The embodiments of the present disclosure may add various modifications in the claims.

### Embodiments

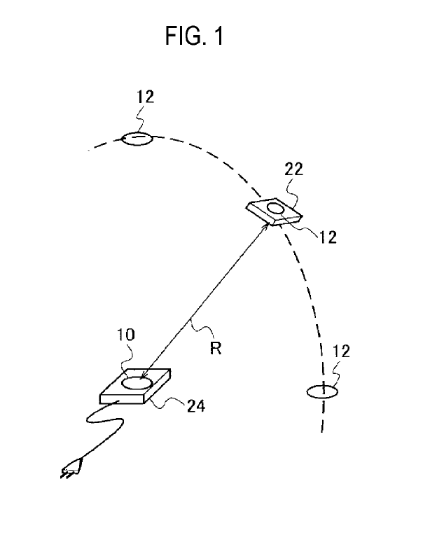

FIG. 1 is a schematic bird's-eye view showing an application of a remote wireless driving charger according to an embodiment of the present disclosure to a mobile phone. As shown in FIG. 1, in this application to a mobile phone 22, a remote wireless driving charger 24 including a primary coil 10 is fixedly located and the mobile phone 22 embedding a secondary coil 12 is placed on a spherical plane at a distance R from the remote wireless driving charger 24.

This embodiment provides a remote wireless driving charger 24 which is capable of freely transmitting power within a service region where the primary coil 10 is a distance of several meters from the secondary coil 12 and is capable of wirelessly and remotely charging and driving the mobile phone 22 with an efficiency of 50% or more without being affected by foreign objects, even if the mobile phone 22 lies at any position in a solid angle.

Although in FIG. 1 the mobile phone 22 is the target of remote wireless driving charging, the present disclosure is not limited thereto. Examples of a remote wireless driving charging target of the remote wireless driving charger 24 according to this embodiment may include other portable devices such as a cordless telephone, a PDA, a portable game machine, a portable music player, a portable DVD player, a digital still/video camera, an electric shaver, an electric toothbrush and so on. The remote wireless driving charger 24 according to this embodiment is a system for remotely driving/charging these portable devices using a coil having a radius of 2 cm to 10 cm in a near field to 3 m range through wireless power transmission.

### (Circuit Configuration)

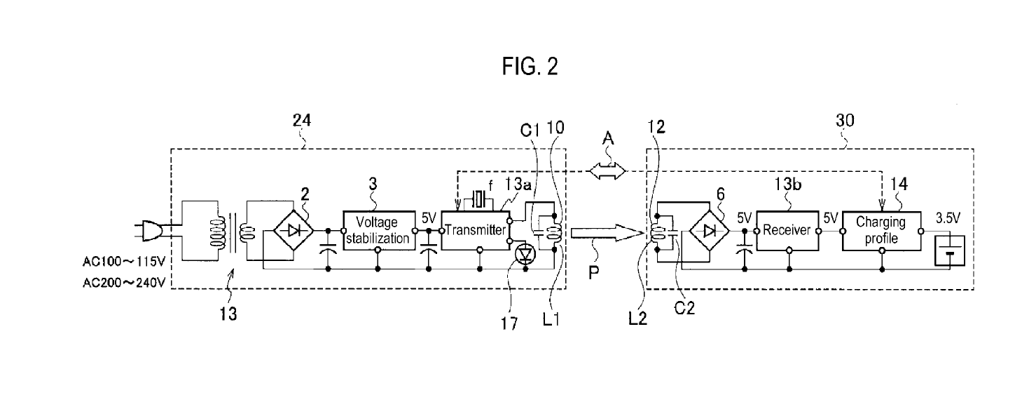

FIG. 2 is a schematic circuit diagram of the remote wireless driving charger 24 according to this embodiment. As shown in FIG. 2, the remote wireless driving charger 24 includes a transmitter 13a, and a primary side resonance capacitor C1 connected to the transmitter 13a. The primary coil 10 is connected to the primary side resonance capacitor C1 and is tuned to be resonant with the primary side resonance capacitor C1 in a predetermined power carrier frequency band. The secondary coil 12 is embedded in a portable device 30, and a secondary side resonance capacitor C2 is connected to the secondary coil 12 and is tuned to be resonant with the secondary coil 12 in the predetermined power carrier frequency band. Radioactive inductance components as micro loops of the primary coil 10 and the secondary coil 12 are cancelled out by the non-radioactive primary side resonance capacitor C1 and secondary side resonance capacitor C2 through an electromagnetic coupling between the primary coil 10 and the secondary coil 12, and the portable device 30 is remotely and wirelessly charged, as indicated by an arrow P.

As shown in FIG. 2, the remote wireless driving charger 24 according to this embodiment may include a magnetic core transformer 13 connected to an AC terminal, a first diode bridge 2 connected to the magnetic core transformer 13, and a voltage stabilization circuit 3 connected to the first diode bridge 2. It is desirable for the transmitter 13a to be connected to the stabilization circuit 3.

In the remote wireless driving charger 24, the predetermined power carrier frequency band is, for example, a shortwave to UHF band of 3 MHz to 3 GHz.

Both the primary coil 10 and the secondary coil 12 have an equivalent radius of about 2 cm to 10 cm, a number of winding turns of about 1 to 10 and a copper volume of about 1 cc to 10 cc.

In the remote wireless driving charger 24, by setting a Q value of self-resonance defined by a ratio of reactance of the primary coil 10 and the secondary coil 12 to radiation loss resistance rr to 50 or more, an effective power transmission efficiency may be maintained at 50% or more, which is almost constant without depending on a distance in a near field to 3 m range irrespective of the presence of metal, foreign objects or a human body in the vicinity of the charger 24.

An indication of a power transmission efficiency calculated in the portable device 30 is provided and the portable device 30 in a near field to 3 mm range from the fixed remote wireless driving charger 24 adjusts the secondary coil 12 to a direction giving maximal sensitivity at any position so that an efficiency of 50% or more can be maintained and wireless power driving charging can be performed while using the portable device 30.

Further, in the wireless power transmission in the near field to 3 mm range, when a direction of the secondary coil 12 relative to the primary coil 10 is adjusted to provide a maximal receiving voltage, fast charging of 5 to 10 minutes can be performed in the portable device 30 and a sign of fast charging can be indicated by an LED indicator 17 connected to the transmitter 13a, thereby avoiding wasteful energy from remote driving and charging.

The transmitter 13a can control tuning by detecting a resonance frequency of the primary coil 10 and a resonance frequency of the secondary coil 12.

In the remote wireless driving charger 24 according to this embodiment, a dropped AC voltage is obtained by stepping down an AC voltage of the AC terminal through the magnetic core transformer 13. Then the dropped AC voltage is bridge-rectified by means of the first diode bridge 2, and the bridge-rectified AC voltage is converted into a low AC voltage in the voltage stabilization circuit 3. The low AC voltage is then automatically adjusted to correspond to an AC input of the transmitter 13a.

The portable device 30 transmits feedback information including detection information of the input voltage to the remote wireless driving charger 24 wirelessly and the remote wireless driving charger 24 receives the feedback information and transmits it to the transmitter 13a.

The portable device 30 may include a second diode bridge 6 connected to the secondary coil 12, a receiver 13b connected to the second diode bridge 6, and a charging profile IC 14 connected to the receiver 13b. The portable device 30 may be configured to transmit feedback information including detection information of the input voltage from the charging profile IC 14 to the transmitter 13a wirelessly.

Further, interactive communication between the transmitter 13a and the charging profile IC 14 is possible, as indicated by an arrow A.

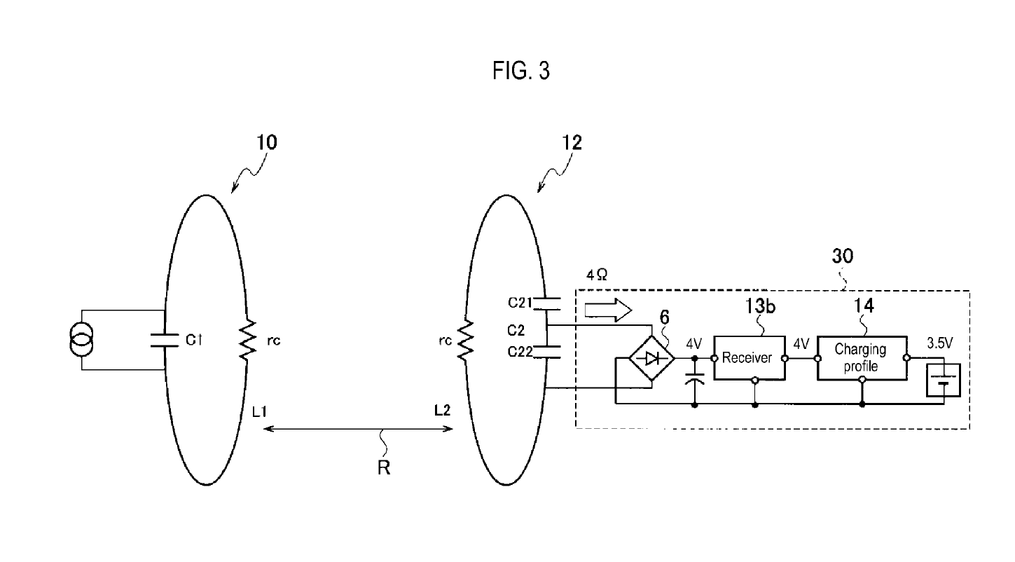

In the remote wireless driving charger 24 according to this embodiment, an example of the primary coil 10 and the secondary coil 12 connected to or embedded in the portable device 30 is as shown in FIG. 3.

In FIG. 3, the equivalent radius a of the primary coil 10 is about 6 cm, the capacitance of the primary side resonance capacitor C1 is about 1.7 nF, and the equivalent resistance rc accompanying copper loss is about 0.0012Ω. The equivalent radius a of the secondary coil 210 is about 6 cm, the capacitance of the secondary side resonance capacitor C2 is about 1.7 nF, the equivalent resistance rc accompanying copper loss is about 0.0012Ω, and the copper volume of each of the primary coil 10 and the secondary coil 12 is about 10 cc. A power carrier frequency is about 10 MHz and the wavelength is about 30 m.

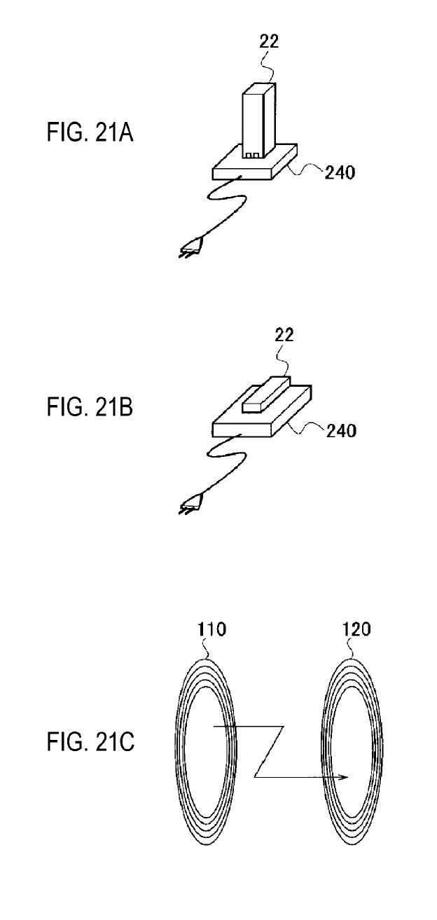

In this configuration, for regular non-contact remote charging, the capacity of a lithium ion battery of the portable device 30 is set to 500 mAh with a reduction of 30% in the capacity. This shows that the average current for a charging of 30 minutes is 1 A, average power consumed at 4 V which is an addition of a terminal voltage 3.5 V and an adjustment voltage drop 0.5 V is 4 W, and average load resistance is 4Ω. In comparison with the experiment as shown in FIG. 21C, the experiment is impractical since a copper volume of 270 cc (considering that the volume of a 10 Yen coin is 1 cc) is used as a coil for the equivalent radius a of 30 cm/the number of winding turns of 5.25. On the contrary, the present embodiment is practical since a copper volume of 10 cc is typically used as a coil for the equivalent radius a of 6 cm/the number of winding turns of 1.

FIG. 3 corresponds to an equivalent circuit for wireless power transmission in a copper loss limit region. As shown in FIG. 3, when the secondary side resonance capacitor C2 is divided into capacitors C21 and C22 and a bridge rectification circuit by the second diode bridge 6 is connected as a load via the capacitor C22, the value of load resistance (in average) is 4Ω.

In the remote wireless driving charger 24 according to this embodiment, for the wireless power transmission charging of the portable device 30, the primary coil 10 and the secondary coil 20 are formed as, for example, insulating air core coils and are proactively loosely coupled. By adding the resonance capacitors C1 and C2 for tuning to the primary coil 10 and the secondary coil 12, respectively, operation impedance is extremely lowered. An effect by the parts, boards and so on equipped in the portable device 30 is reduced relatively and power transmission efficiency, convenience, generality and so on are acceptable with practicability.

The common non-contact remote wireless driving charger can be used for almost all portable information devices and these portable devices can be remotely driven and charged with an efficiency of 50% or more by using coils of a radius of 2 cm to 10 cm in the near field to 3 mm range through the wireless power transmission.

It is known in the remote wireless driving charger 24 according to this embodiment that radiation and reception performance of antenna coils have no relationship with coil size. In addition, it is apparent that the wireless power transmission efficiency is constant in the near field to 3 m range and close adhesion between the coils is not necessarily advantageous.

Further, in the remote wireless driving charger 24 according to this embodiment, it is shown that the secondary coil 12 embedded in the portable device 30 is not affected by a metal chassis.

The remote wireless driving charger 24 may include a security mechanism for supplying power to an authenticated portable device 30 by detecting the approach of an object (foreign object), which is not originally a power feeding target, or identifying a rightful power feeding target. For example, the remote wireless driving charger 24 may include the function of transmitting an authentication data signal between the remote wireless driving charger 24 and a coil of the portable device 30 wirelessly. In this case, the primary coil 10 and the secondary coil 12 act as antennas for transmitting the data signal wirelessly.

As described above, in the remote wireless driving charger 24 according to this embodiment, driving charging can be performed while using the portable device 30.

### (Authentication Function)

In this embodiment, for an authentication function between the portable device 30 embedding the receiver 13b and the remote wireless driving charger 24 including the transmitter 13a, the portable device 30 sends an authentication signal to the remote wireless driving charger 24. Under the condition where the portable device 30 is remotely located and faces the remote wireless driving charger 24, when a, for example, button of the portable device 30 is pressed, authentication data is sent from the portable device 30 to the remote wireless driving charger 24. Upon receiving the authentication data, the LED indicator 17 in the remote wireless driving charger 24 is turned on for confirmation.

An input voltage of the transmitter 13a is, for example, about DC 5 V and charging current supplied to a secondary cell (i.e., the lithium ion battery) by the receiver 13b is, for example, about 300 mA. An authentication data transmission speed is about 1.2 Kbits/sec. The thickness of the remote wireless driving charger 24 including the transmitter 13a is about 8 mm. Dimensions of the primary coil 10 and the secondary coil 12 are, for example, about 28 mm in diameter and about 1 mm in thickness. Thus, weak power of 3 W can be transmitted wirelessly and coreless. The wireless power transmission efficiency depends on the configuration and so on of peripheral circuits, and therefore a percentage of power supplied to the secondary cell by an input power of DC 5 V is 50 to 70%.

As another example, a transmission efficiency of a DC voltage supplied to the transmitter 13a is about 70%. An efficiency of power transmission between the primary coil 10 and the secondary coil 12 reaches 90%. Dimensions of the coils are, for example, about 30 mm in diameter and about 1 mm at the maximum in thickness. Thus, power of about 3 W can be transmitted wirelessly. By increasing the transmission speed to 10 Mbits/sec, other information besides the authentication data can be transmitted.

In the remote wireless driving charger 24 according to this embodiment, as shown in FIG. 2, the magnetic core transformer 13 for insulating and voltage drop in the remote wireless driving charger 24 is left unchanged and the excitation current always flows through the magnetic core transformer 13. An input voltage of the transmitter 13a of the remote wireless driving charger 24 is stabilized and is, for example, about 5 V. A transmission frequency f is determined by a ceramic resonator or the like of the transmitter 13a. The LED indicator 17 can indicate that the remote wireless driving charger 24 is charging the portable device 30. The remote wireless driving charger 24 can determine whether a charging target is a foreign object or the portable device 30. The portable device 30 can charge a 3.5 V battery by dropping a voltage of 5 V according to a charging profile. In addition, as described above, interactive communication can be conducted between the remote wireless driving charger 24 and the portable device 30.

Under the condition where a primary winding of the transformer required for insulation of the charger is included in the remote wireless driving charger 24, a secondary winding thereof is embedded in the portable device 30 and no contact therebetween is made, it may be considered to achieve low cost, non-contact, high efficiency, lightness and high reliability of the charging system by sending a control signal from the primary side to the secondary side. An optimal power transmission frequency and the best electronic coupling may be selected for configuration.

### (Basic Characteristics of Micro Loop)

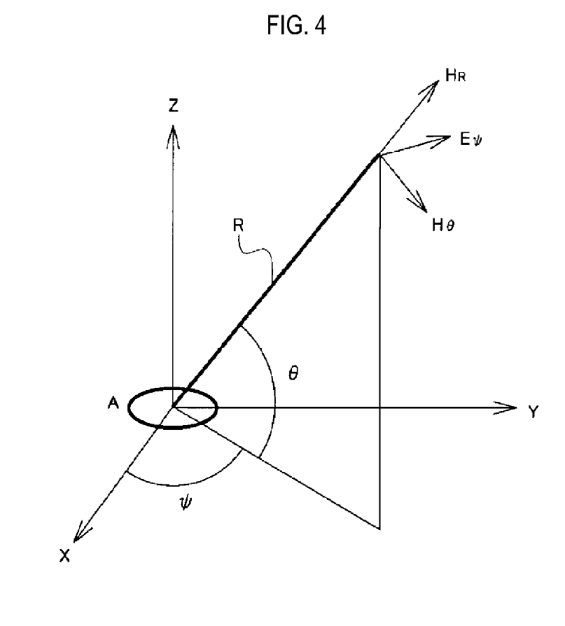

FIG. 4 is a three-dimensional coordinate system representation for explaining near field/far field radiation of a micro loop A.

The micro loop A shown in FIG. 4 is dedicated for a transmitting and receiving antenna for wireless power transmission. In conventional antenna/radio wave engineering, a micro resonance radiation element dipole and a micro loop have not been examined in detail due to impracticability. A starting point is to understand the characteristics of the micro loop specifically.

Equations 1 and 2 represent a radiation magnetic field from a micro loop. These two equations are derived from an equation of Biot-Savart Law with an additional light flux delay term, exp(−jkR), other than Maxwell's electromagnetic equation.

The description regarding the remote wireless power transmission effect by the remote wireless driving charger 24 according to this embodiment demonstrates that Equations 1 and 2 are correct.

Equation 1 represents a magnetic field H_{R} used for remote wireless driving charging of the portable device 30 co-axially arranged. In the equation, * represents a multiplication sign (the rest is the same as above).

$${H}_{R} = \frac{iA}{2 π} ( \frac{1}{{R}^{3}} + \frac{jk}{{R}^{2}} ) sin θ * {e}^{- j k R} \qquad [ Equation 1 ]$$

Equation 2 represents a magnetic field Ho used for remote wireless driving and charging of the portable device 30 arranged on the co-plane.

$${H}_{θ} = \frac{iA}{4 π} ( - \frac{1}{{R}^{3 }} - \frac{jk}{{R}^{2}} + \frac{{k}^{2}}{R} ) cos θ * {e}^{- j kR} \\ A = π {a}^{2} \\ k = 2 π / λ \qquad [ Equation 2 ]$$

Equations 1 and 2 are understood in common to all researchers, technicians and students who engage in electromagnetics/antenna optics/radio wave engineering. If a shortwave to UHF band (3 MHz to 3 GHz) is used as a wireless power carrier and a distance between the primary coil 10 of the remote wireless driving charger 24 and the secondary coil 12 of the portable device 30 is set to be about 3 mm, these coils are within a near field range (R<λ<2η) of mutual coil radiation.

Researchers of an experiment in the related art, as shown in FIG. 21C, assert through wireless power transmission experiments that things other than those known from an understanding of classical electromagnetics occur in resonance phenomena. However, these experiments cannot provide the theoretical basis for those things. Neither scientists nor the researchers of the experiment in the related art have envisaged that, when a primary coil and a secondary coil are located at a distance R which is several or several tens of times as large as the common radius a of the primary coil and the secondary coil, action current flowing through the primary coil induces induction current having the same magnitude in the secondary coil.

First, for electromagnetic wave energy radiation according to Oliver Heaviside, Equation 3 represents a ratio ηs of an area of a coil having a radius a of 6 cm to a surface area of a sphere having a radius of 3 m, where the secondary coil 12 of the portable device 30 has a radius a of 6 cm and is located at a distance R of 3 m from the charger, as expressed below.

$$Ratio of coil area to spherical surface area \text{:} \\ {η}_{s} = \frac{π {a}^{2}}{4 π {R}^{2}} = \frac{π * {0.06}^{2}}{4 π * {3}^{2}} = 0.0001 \qquad [ Equation 3 ]$$

Therefore, an effect that an efficiency of 50% is obtained cannot be explained even when a power transmission efficiency of 0.01% is achieved.

In transformer design theory, a magnetic coupling coefficient k between electromagnetic inductive coils determines the power transmission efficiency based on Faraday's Law. If two coils having a radius a of 6 cm face each other at a distance of 3 m, the magnetic coupling coefficient k is expressed by Equation 4, as is widely known in the art.

$$Magnetic coupling coefficient \text{:} \\ \begin{matrix}k = 120 {π}^{3} ( \frac{a}{λ} ) {( \frac{a}{R} )}^{3} \\ = 120 {π}^{3} ( \frac{0.06}{30} ) {( \frac{0.06}{3} )}^{3} \\ = 0.00006\end{matrix} \qquad [ Equation 4 ]$$

For electromagnetic induction according to Faraday, power transmission efficiency at a distance R=3 m has to be about 0.006%. However, in actuality, the power transmission efficiency is about 50%.

With these two efficiencies, the power transmission efficiency of 50% or so in the above-described experiment as shown in FIG. 21C and the remote wireless driving charger 24 according to this embodiment, the electromagnetic energy radiation of Oliver Heaviside and the electromagnetic induction of Faraday cannot be properly applied to what is occurring. This may be overlooked with a superficial understanding of electromagnetics, but it is a common electromagnetic property, as will be described later.

### (Relative Position Between Remote Wireless Driving Charger and Portable Device)

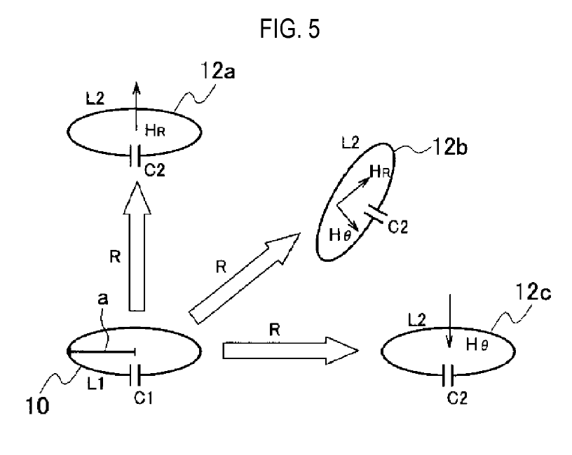

FIG. 5 is a schematic view for explaining an effect of remote wireless coupling between a secondary coil 12a placed co-axially, a secondary coil 12c placed on a co-plane, and a secondary coil 12b placed randomly with respect to the primary coil 10 in the remote wireless driving charger 24 according to this embodiment.

In the experiment shown in FIG. 21C, two coils face each other and have sections as large as possible and the number of winding turns as high as possible to secure a magnetic coupling without completely putting the Heaviside's radiation idea away, Instead of basically selecting that magnetic coupling, the remote wireless driving charger 24 of this embodiment allows a secondary coil 12 to transmit power at any position with a position of the primary coil 10 as the origin of the Cartesian coordinate system, as shown in FIG. 5, when the portable device 30 is wirelessly charged/driven at a near field to 3 m range indoor from the remote wireless driving charger 24.

In the remote wireless driving charger 24 according to this embodiment, only a co-axial magnetic field H_{R} appears in the secondary coil 12a having an inductance L2, which is co-axially placed with respect to the primary coil 10 placed at the origin of the Cartesian coordinate system and having an inductance L1. Only a θ-directed magnetic field H_{θ} appears in the secondary coil 12c which is placed on the co-plane with respect to the primary coil 10 placed at the origin of the Cartesian coordinate system. A combination of two basic elements, i.e., the distance R-directed magnetic field H_{R} and the O-directed magnetic field H_{θ}, appears in the secondary coil 12b placed randomly, as shown in FIG. 5.

### (Equivalent Circuit for Power Transmission)

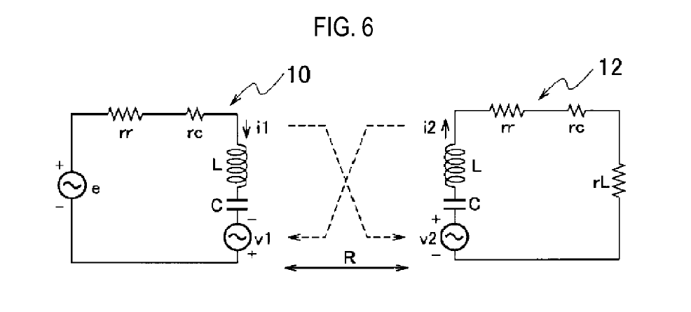

FIG. 6 is an equivalent circuit diagram of wireless power transmission in consideration of both the radiation loss resistance rr and copper loss resistance rc in the remote wireless driving charger 24 according to this embodiment.

As shown in FIG. 6, the primary coil 10 included in the remote wireless driving charger 24 is shown in a series circuit including radiation loss resistance rr accompanying radiation loss at infinity, copper loss resistance rc accompanying winding copper loss, an inductance L1, a primary side resonance capacitor C1 and a reverse induction voltage v1. An excitation voltage e is connected to this series circuit to flow primary side excitation current i1 therethrough.

In addition, as shown in FIG. 6, the secondary coil 12 embedded in the portable device 30 is shown in a series circuit including radiation loss resistance rr accompanying radiation loss at infinity, equivalent resistance rc accompanying winding copper loss, an inductance L2, a secondary side resonance capacitor C2 and an induction voltage v2. Load resistance rL is connected to this series circuit to flow secondary side induction current i2 therethrough.

The equivalent radius of each of the primary coil 10 and the secondary coil 12 is denoted by a, a power carrier frequency is, for example, about 10 MHz, and a wavelength is about 30 mm.

Reactance components of the inductance L1 of a micro loop1 of the primary coil 10 and the inductance L2 of a micro loop2 of the secondary coil 12 are respectively cancelled out by the resonance capacitors C1 and C2.

The micro loop1 of the primary coil 10 is driven by the excitation voltage e to flow the primary side excitation current i1 therethrough.

The secondary side induction current i2 by the primary side excitation current i1 is flown through the micro loop2 of the secondary coil 12 having the load resistance rL.

The reverse induction voltage v1 is induced in the micro loop1 of the primary coil 10 by re-radiation of the secondary side induction current i2.

For the purpose of simplification, the primary coil 10 included in the remote wireless driving charger 24 according to this embodiment has the same shape as the secondary coil 12 embedded in the portable device 30. Effective power Pᵢₙ input to the system is a vector inner product of the excitation voltage e and the primary side excitation current i1, as expressed by Equation 5.

$$Power input to loop 1 \text{:} \\ {P}_{i n} = e \times {i}_{1} \\ ( vector inner product ) \qquad [ Equation 5 ]$$

On the other hand, power Pₒᵤₜ transmitted to the load resistance rL is expressed by Equation 6.

Power transmitted to load resistance: Pₒᵤₜ=r_{L}*|i₂|² [Equation 6]

Accordingly, power transmission efficiency is expressed by Equation 7. Power transmission efficiency has a positive value and will not be larger than 1 as long as the law f energy conservation is established.

Wireless power transmission efficiency: η=Pₒᵤₜ/Pᵢₙ [Equation 7]

The coil radiation loss resistances rr of the primary coil 10 and the secondary coil 12 are not independent of each other. This is because the radiation loss resistance rr accompanying the radiation loss at infinity becomes zero if a distance between the two coils is smaller than the wavelength λ, the magnitudes of currents flowing in the same direction are equal to each other, and a phase is shifted by 180 degrees as in Lentz's law. Considering that the two coil radiation loss resistances rr are not independent of each other, Ohm's law for the loop1 after the reactance components disappear is expressed by Equation 8. rc denotes the winding copper loss resistance. Here, dielectric loss of the resonance capacitor is disregarded.

$${Ohm}^{′} s law for loop 1 at a resonance point \text{:} \\ {i}_{1} = \frac{( e + {v}_{1} )}{( rr + rc )} = \frac{( e + {v}_{1} )}{rr ( 1 + {m}_{0} )} \\ {m}_{0} = \frac{rc}{rr} \qquad [ Equation 8 ]$$

Similarly, Ohm's law for the loop2 is expressed by Equation 9. rL denotes load resistance of wireless power transmission.

$${Ohm}^{′} s law for loop 2 at a resonance point \text{:} \\ {i}_{2} = \frac{{v}_{2}}{( rr + rc + {r}_{L} )} = \frac{{v}_{2}}{rr ( 1 + {m}_{0} + {m}_{L} )} \\ {m}_{L} = \frac{{r}_{L}}{rr} \qquad [ Equation 9 ]$$

Equations 5 to 9 are based on fundamental electromagnetics, which is regarded as an absolute truth.

### (Wireless Power Transmission Efficiency for Co-Axial Arrangement)

The experiment as shown in FIG. 21C considers a magnetic coupling in co-axial arrangement of two opposite coils. In contrast, the remote wireless driving charger 24 of this embodiment considers a general representation by a combination of co-axial arrangement and co-planar arrangement and no separate use of an electric field E and a magnetic field H.

First, co-axial arrangement is considered. A relationship between the excitation current it and the induction current i2 will be described below with an expression representing the function of the distance R by introducing a magnetic field into the expression. In such relationship, the excitation current i1 flowing through the primary coil 10 composed of the micro loop1 having the radius a induces the induction current i2 in the secondary coil 12 composed of the micro loop2 which is separated by a distance R from the loop1, has the same radius a, and is connected to the load resistance rL.

Only a near field magnetic field H_{R} due to the excitation current i1 exists on the co-axis on which the secondary coil 12 is located and this magnetic field H_{R} is expressed by Equation 10.

$$Magnetic field intensity on co \text{-} axis : \\ {H}_{R} = \frac{{i}_{1} * ( π {a}^{2} )}{2 π} \{ \frac{1}{{R}^{3}} + \frac{jk}{{R}^{2}} \} * {e}^{- j kR} \qquad [ Equation 10 ]$$

Accordingly, if Faraday's law is correct, the induction voltage v2 of the secondary coil 12 is expressed by Equation 11 which is a form of a time-derivative of Equation 10. In Equation 11, ω denotes an angular frequency and μ₀ denotes vacuum permeability.

$$Induction voltage \text{:} \\ \begin{matrix}{v}_{2} = j ω {μ}_{0} {H}_{R} * ( π {a}^{2} ) \\ = \frac{j ω {μ}_{0} {i}_{1} * {( π {a}^{2} )}^{2}}{2 π} \{ \frac{1}{{R}^{3}} + \frac{jk}{{R}^{2}} \} * {e}^{- j kR}\end{matrix} \\ {μ}_{0} = 4 π \times {10}^{- 7} \qquad [ Equation 11 ]$$

Since the reactance component of the inductance L2 of the secondary coil 12 is cancelled out by the resonance capacitor C2, the induction current i2 of the secondary coil 12 with respect to the excitation current i1 of the primary coil 10 is expressed by Equation 12, where i1 and i2 are assumed to span a light flux delay term exp(−jkR) over a phase shifted by 90 degrees. Although Lentz's law represents that an introduced magnetic field is eliminated in an inner side of a coil and is strengthened in an outer side of the coil if the coil is short-circuited by self-inductance, if the coil is terminated with pure resistance, there exists no event of the elimination of the introduced magnetic field. Lentz's law cannot be applied with generality when induction of a dipole is also included.

$$\begin{matrix}Induction current i 2 \text{:} & [ Equation 12 ] \\ \begin{matrix}{i}_{2} = \frac{{v}_{2}}{rr ( 1 + {m}_{0} + {m}_{L} )} \\ = \frac{\frac{j ω {μ}_{0} {i}_{1} * {( π {a}^{2} )}^{2}}{2 π} \{ \frac{1}{{R}^{3}} + \frac{jk}{{R}^{2}} \} * {e}^{- j k R}}{31200 {{π}^{2} ( a / λ )}^{4} ( 1 + {m}_{0} + {m}_{L} )} \\ = {i}_{1} \frac{{π}^{4}}{32.5 ( 1 + {m}_{0} + {m}_{L} )} \{ {j ( \frac{λ}{2 π R} )}^{3} - {( \frac{λ}{2 π R} )}^{2} \} * \\ {e}^{- j kR}\end{matrix} & \end{matrix}$$

Equation 12 does not include the radiuses a of the primary coil 10 and the secondary coil 12. Although the experiment shown in FIG. 21C makes the coil radiuses as large as possible, since it is limited to the idea of energy radiation of Heaviside, wireless power transmission has no essential relationship with the coil radiuses a.

In the relationship of R<λ/2η, the induction current i2 is about equal to or larger than the excitation current i1. In the relationship of R>>λ/2η, the induction current i2 become small in inverse proportion to the distance as compared to the excitation current i1 and thus is not used for the wireless power transmission. Ohm's law in the primary coil 10 is established between an addition of the voltage v1 induced in the primary coil 10 by the induction current i2 to the excitation voltage e and the excitation current i2, as expressed by Equation 13.

$$\begin{matrix}Excitation current \text{:} \\ \begin{matrix}{i}_{1} = \frac{( e + {v}_{1} )}{rr ( 1 + {m}_{0} )} \\ = \frac{[ e + \frac{j {ωμ}_{0} {i}_{2} * {( π {a}^{*} )}^{*}}{2 π} \{ \frac{1}{{R}^{3}} + \frac{jk}{{R}^{2}} \} * {e}^{- j kR} ]}{31200 {{π}^{2} ( a / λ )}^{4} ( 1 + {m}_{0} )}\end{matrix} & [ Equation 13 ] \\ = \frac{[ \begin{matrix}e + \frac{\begin{matrix}\begin{matrix}j ω {μ}_{0} {i}_{1} \frac{{π}^{4}}{32.5 ( 1 + {m}_{0} + {m}_{L} )} \\ \{ {j ( \frac{λ}{2 π R} )}^{3} - {( \frac{λ}{2 π R} )}^{2} \} *\end{matrix} \\ {e}^{- j k R} * {( π {a}^{2} )}^{2}\end{matrix}}{2 π} \\ \{ \frac{1}{{R}^{3 }} + \frac{jk}{{R}^{2}} \} * {e}^{- j kR}\end{matrix} ]}{31200 {{π}^{2} ( a / λ )}^{4} ( 1 + {m}_{0} )} & \\ = \frac{[ \begin{matrix}\frac{e}{{( a / λ )}^{4}} + {i}_{1} \frac{960 {π}^{10}}{32.5 ( 1 + {m}_{0} + {m}_{L} )} \\ {\{ {j ( \frac{λ}{2 π R} )}^{3} - {( \frac{λ}{2 π R} )}^{2} \}}^{2} * {e}^{- j 2 kR}\end{matrix} ]}{31200 {π}^{2} ( 1 + {m}_{0} )} & \end{matrix}$$

Accordingly, when the induction current i2 is induced (that is, produced by a reaction of the second coil 12), the relationship between the excitation e and the excitation current i1 is expressed by Equation 14.

$$∴ {i}_{1} [ \begin{matrix}31200 {π}^{2} ( 1 + {m}_{0} ) - \frac{29.54 {π}^{10}}{( 1 + {m}_{0} + {m}_{L} )} \\ {\{ {j ( \frac{λ}{2 π R} )}^{3} - {( \frac{λ}{2 π R} )}^{2} \}}^{2} * {e}^{- j 2 kR}\end{matrix} ] = \frac{e}{{( a / λ )}^{4}} \qquad [ Equation 14 ]$$

The input power Pᵢₙ is a vector inner product of the excitation voltage e and the excitation current i1 and is expressed by Equation 15.

$${P}_{i n} = {{i}_{1}^{2} ( a / λ )}^{4} {π}^{2} [ \begin{matrix}31200 ( 1 + {m}_{0} ) - \frac{29.54 {π}^{8}}{( 1 + {m}_{0} + {m}_{L} )} \\ {Re [ {j ( \frac{λ}{2 π R} )}^{3} - {( \frac{λ}{2 π R} )}^{2} \}}^{2} * {e}^{- j 2 kR}\end{matrix} ] \qquad [ Equation 15 ]$$

On the other hand, the power Pₒᵤₜ transmitted to the load resistance rL is expressed by Equation 16.

$${P}_{out} = 31200 {{π}^{2} ( a / λ )}^{4} * {m}_{L} * {\vert {i}_{1} \frac{{π}^{4}}{32.5 ( 1 + {m}_{0} + {m}_{L} )} \{ {j ( \frac{λ}{2 π R} )}^{3} - {( \frac{λ}{2 π R} )}^{2} \} * {e}^{- j kR} \vert}^{2} \qquad [ Equation 16 ]$$

The power transmission efficiency η is expressed by Equation 17 without any abbreviation.

$$\begin{matrix}η = \frac{\begin{matrix}31200 {{π}^{2} ( a / λ )}^{4} * {m}_{L} * \\ {\vert {i}_{1} \frac{{π}^{4}}{32.5 ( 1 + {m}_{0} + {m}_{L} )} \{ {j ( \frac{λ}{2 π R} )}^{3} - {( \frac{λ}{2 π R} )}^{2} \} * {e}^{- j kR} \vert}^{2}\end{matrix}}{{{i}_{1}^{2} ( a / λ )}^{4} {π}^{2} [ \begin{matrix}31200 ( 1 + {m}_{0} ) - \frac{29.54 {π}^{8}}{( 1 + {m}_{0} + {m}_{L} )} \\ {Re [ {j ( \frac{λ}{2 π R} )}^{3} - {( \frac{λ}{2 π R} )}^{2} \}}^{2} * {e}^{- j 2 kR} ]\end{matrix} ]} \\ = \frac{\frac{29.54 {π}^{8} * {m}_{L}}{{( 1 + {m}_{0} + {m}_{L} )}^{2}} * {\vert \{ {j ( \frac{λ}{2 π R} )}^{3} - {( \frac{λ}{2 π R} )}^{2} \} \vert}^{2}}{[ \begin{matrix}31200 ( 1 + {m}_{0} ) - \frac{29.54 {π}^{8}}{( 1 + {m}_{0} + {m}_{L} )} \\ {Re [ {j ( \frac{λ}{2 π R} )}^{3} - {( \frac{λ}{2 π R} )}^{2} \}}^{2} * {e}^{- j 2 kR} ]\end{matrix} ]} \\ = \frac{{m}_{L} * {\vert \{ {j ( \frac{λ}{2 π R} )}^{3} - {( \frac{λ}{2 π R} )}^{2} \} \vert}^{2}}{\begin{matrix}{( \frac{65}{2 {π}^{4}} )}^{2} ( 1 + {m}_{0} ) {( 1 + {m}_{0} + {m}_{L} )}^{2} - ( 1 + {m}_{0} + {m}_{L} ) * \\ {Re [ {j ( \frac{λ}{2 π R} )}^{3} - {( \frac{λ}{2 π R} )}^{2} \}}^{2} * {e}^{- j 2 kR}\end{matrix}}\end{matrix} \qquad [ Equation 17 ]$$

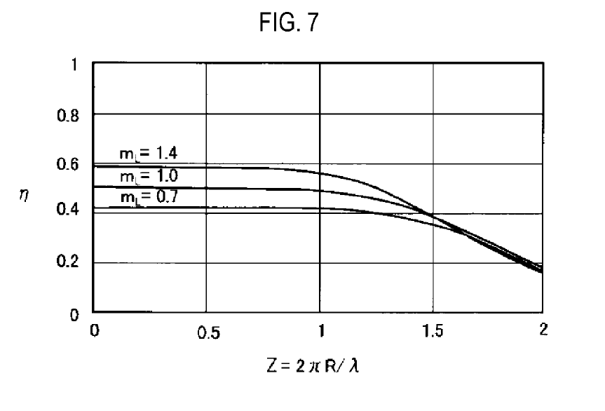

In the remote wireless driving charger 24 according to this embodiment, assuming that two coil radiation loss resistances are independent of each other under the condition of rc<<rr (copper loss is negligibly smaller than radiation loss), a relationship between a distance R and the power transmission efficiency η in the co-axial arrangement for mL=0.7 to 1.4 is as shown in FIG. 7. mL=1 corresponds to a case where the load resistance rL is equivalent to the radiation loss resistance rr. Under the above presumption, it can be seen that efficiency in a near field to λ/2η range is not significantly changed.

As the two coil radiation loss resistances are in fact not independent of each other, there exists some error between the actual situation and Equation 17 calculated under the premise that the two coil radiation loss resistances are independent of each other.

In this manner, using the shortwave to UHF (3 MHz to 3 GHz) frequency band, power transmission efficiency of 50% or more in a near field to 3 m range can be achieved by the above co-axial arrangement.

### (Wireless Power Transmission Efficiency for Co-Planar Arrangement)

In a co-planar arrangement, a far field magnetic field is added to the near field magnetic field due to the excitation current i1. The sensitivity of induction for the co-planar arrangement is about ½ of that for the co-axial arrangement, as expressed by Equation 18.

$$Co \text{-} planar magnetic field intensity \text{:} \\ {H}_{θ} = \frac{{i}_{1} * ( π {a}^{2} )}{4 π} \{ - \frac{1}{{R}^{3 }} - \frac{jk}{{R}^{2}} + \frac{{k}^{2}}{R} \} * {e}^{- j kR} \qquad [ Equation 18 ]$$

The induction voltage v2 of the secondary coil 12 by the excitation current i1 of the primary coil 10 may be expressed by Equation 19.

$$Induction voltage \text{:} \\ {v}_{2} = \frac{j ω {μ}_{0} {i}_{1} * {( π {a}^{2} )}^{2}}{4 π} \{ - \frac{1}{{R}^{3}} - \frac{jk}{{R}^{2}} + \frac{{k}^{2}}{R} \} * {e}^{- j kR} \qquad [ Equation 19 ]$$

The induction current i2 of the secondary coil 12 may be expressed by Equation 20.

$$Induction current i 2 \text{:} \\ \begin{matrix}{i}_{2} = \frac{{v}_{2}}{rr ( 1 + {m}_{0} + {m}_{L} )} \\ = \frac{\frac{j ω {μ}_{0} {i}_{1} * {( π {a}^{2} )}^{2}}{4 π} \{ - \frac{1}{{R}^{3}} - \frac{j k}{{R}^{2}} + \frac{{k}^{2}}{R} \} * {e}^{- j kR}}{31200 {{π}^{2} ( a / λ )}^{4} ( 1 + {m}_{0} + {m}_{L} )} \\ = {i}_{1} \frac{{π}^{4}}{65 ( 1 + {m}_{0} + {m}_{L} )} \{ \begin{matrix}- {j ( \frac{λ}{2 π R} )}^{3} + {( \frac{λ}{2 π R} )}^{2} + \\ j ( \frac{λ}{2 π R} )\end{matrix} \} * \\ {e}^{- j kR}\end{matrix} \qquad [ Equation 20 ]$$

When the induction current i2 exists, the excitation current i1 is expressed by Equation 21.

$$\begin{matrix}Excitation current \text{:} & [ Equation 21 ] \\ \begin{matrix}{i}_{1} = \frac{( e + {v}_{1} )}{rr ( 1 + {m}_{0} )} \\ = \frac{[ \begin{matrix}e + \frac{j {ωμ}_{0} {i}_{2} * {( π {a}^{2} )}^{2}}{4 π} \\ \{ - \frac{1}{{R}^{3}} - \frac{j k}{{R}^{2}} + \frac{{k}^{2}}{R} \} * {e}^{- j kR}\end{matrix} ]}{31200 {{π}^{2} ( a / λ )}^{4} ( 1 + {m}_{0} )} \\ = \frac{[ \begin{matrix}e + \frac{\begin{matrix}\begin{matrix}\frac{j ω {μ}_{0} {i}_{1} {π}^{4}}{65 ( 1 + {m}_{0} + {m}_{L} )} \\ \{ - {j ( \frac{λ}{2 π R} )}^{3} + {( \frac{λ}{2 π R} )}^{2} + j ( \frac{λ}{2 π R} ) \} *\end{matrix} \\ {{e}^{- j kR} ( π {a}^{2} )}^{2}\end{matrix}}{4 π} * \\ \{ - \frac{1}{{R}^{3}} - \frac{j k}{{R}^{2}} + \frac{{k}^{2}}{R} \} * {e}^{- j kR}\end{matrix} ]}{31200 {{π}^{2} ( a / λ )}^{4} ( 1 + {m}_{0} )} \\ = \frac{[ \begin{matrix}\begin{matrix}\frac{e}{{( a / λ )}^{4}} - {i}_{1} \frac{480 {π}^{10}}{65 ( 1 + {m}_{0} + {m}_{L} )} \\ {\{ - {j ( \frac{λ}{2 π R} )}^{3} + {( \frac{λ}{2 π R} )}^{2} + j ( \frac{λ}{2 π R } ) \}}^{2} *\end{matrix} \\ {e}^{- j 2 kR}\end{matrix} ]}{31200 {π}^{2} ( 1 + {m}_{0} )}\end{matrix} & \end{matrix}$$

Accordingly, a relationship between an application voltage e and the excitation current i1 is expressed by Equation 22.

$$∴ {i}_{1} {π}^{2} [ \begin{matrix}31200 ( 1 + {m}_{0} ) - \frac{7.38 {π}^{8}}{( 1 + {m}_{0} + {m}_{L} )} \\ {\{ - {j ( \frac{λ}{2 π R} )}^{3} + {( \frac{λ}{2 π R} )}^{2} + j ( \frac{λ}{2 π R} ) \}}^{2} * {e}^{- j 2 π β R}\end{matrix} ] = \frac{e}{{( a / λ )}^{4}} \qquad [ Equation 22 ]$$

The input power Pᵢₙ by a driving stage voltage e of the primary coil 10 is expressed by Equation 23.

$${P}_{i n} = {{i}_{1}^{2} ( a / λ )}^{4} {π}^{2} [ \begin{matrix}31200 ( 1 + {m}_{0} ) - \frac{7.38 {π}^{8}}{( 1 + {m}_{0} + {m}_{L} )} \\ {Re [ - {j ( \frac{λ}{2 π R} )}^{3} + {( \frac{λ}{2 π R} )}^{2} + j ( \frac{λ}{2 π R} ) \}}^{2} * {e}^{- j 2 kR}\end{matrix} ] \qquad [ Equation 23 ]$$

The power Pₒᵤₜ transmitted to the load resistance rL connected to the secondary coil 12 is expressed by Equation 24.

$${P}_{out} = 31200 {{π}^{2} ( a / λ )}^{4} * {m}_{L} * {\vert \begin{matrix}{i}_{1} \frac{{π}^{4}}{65 ( 1 + {m}_{0} + {m}_{L} )} \\ \{ - {j ( \frac{λ}{2 π R} )}^{3} + {( \frac{λ}{2 π R} )}^{2} + j ( \frac{λ}{2 π R} ) \} * {e}^{- j kR}\end{matrix} \vert}^{2} \qquad [ Equation 24 ]$$

Accordingly, the power transmission efficiency is expressed by Equation 25.

$$\begin{matrix}η = \frac{\begin{matrix}31200 {{π}^{2} ( a / λ )}^{4} * {m}_{L} * \\ \vert \begin{matrix}\begin{matrix}{i}_{1} \frac{{π}^{4}}{65 ( 1 + {m}_{0} + {m}_{L} )} \\ \{ - {j ( \frac{λ}{2 π R} )}^{3} + {( \frac{λ}{2 π R} )}^{2} + j ( \frac{λ}{2 π R} ) \} *\end{matrix} \\ {e}^{- j k R}\end{matrix} \vert\end{matrix}}{{{i}_{1}^{2} ( a / λ )}^{4} {π}^{2} [ \begin{matrix}31200 ( 1 + {m}_{0} ) - \frac{7.38 {π}^{8}}{( 1 + {m}_{0} + {m}_{L} )} \\ Re [ \begin{matrix}{\begin{matrix}- {j ( \frac{λ}{2 π R} )}^{3} + {( \frac{λ}{2 π R} )}^{2} + \\ j ( \frac{λ}{2 π R} )\end{matrix} \}}^{2} * \\ {e}^{- j 2 kR}\end{matrix} ]\end{matrix} ]} \\ = \frac{{m}_{L} * {\vert \{ - {j ( \frac{λ}{2 π R} )}^{3} + {( \frac{λ}{2 π R} )}^{2} + j ( \frac{λ}{2 π R} ) \} \vert}^{2}}{[ \begin{matrix}{( \frac{65}{{π}^{4}} )}^{2} ( 1 + {m}_{0} ) {( 1 + {m}_{0} + {m}_{L} )}^{2} - \\ ( 1 + {m}_{0} + {m}_{L} ) \\ Re [ \begin{matrix}{- {j ( \frac{λ}{2 π R} )}^{3} + {( \frac{λ}{2 π R} )}^{2} + j ( \frac{λ}{2 π R} ) \}}^{2} * \\ {e}^{- j 2 kR}\end{matrix} ]\end{matrix} ]}\end{matrix} \qquad [ Equation 25 ]$$

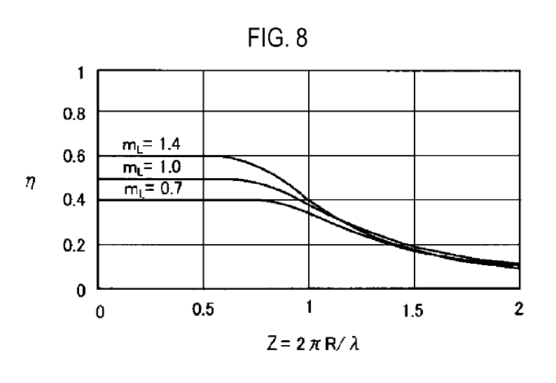

In the remote wireless driving charger 24 according to this embodiment, assuming that two coil radiation loss resistances are independent of each other under the condition of rc<<rr (copper loss is negligibly smaller than radiation loss), a relationship between a distance R and the power transmission efficiency η in the co-planar arrangement for mL=0.7 to 1.4 is as shown in FIG. 8. mL=1 corresponds to a case where the load resistance rL is equivalent to the radiation loss resistance rr. Under the above presumption, it can be seen that efficiency in a near field to λ/2η range is not significantly changed.

As the two coil radiation loss resistances are in fact not independent of each other, there exists some error between the actual situation and Equation 25 calculated under the premise that the two coil radiation loss resistances are independent of each other.

In the co-planar arrangement, since a term inversely proportional to the distance R to the first power is added to a term inversely proportional to the distance R cubed, the power transmission efficiency η more quickly declines than that of the co-axial arrangement near R=η/2η.

In this manner, using the shortwave to UHF (3 MHz to 3 GHz) frequency band, power transmission efficiency of 50% or more in a near field to 3 m range can be achieved by the above co-planar arrangement.

### (Random Combination of Co-Axial Arrangement and Co-Planar Arrangement)

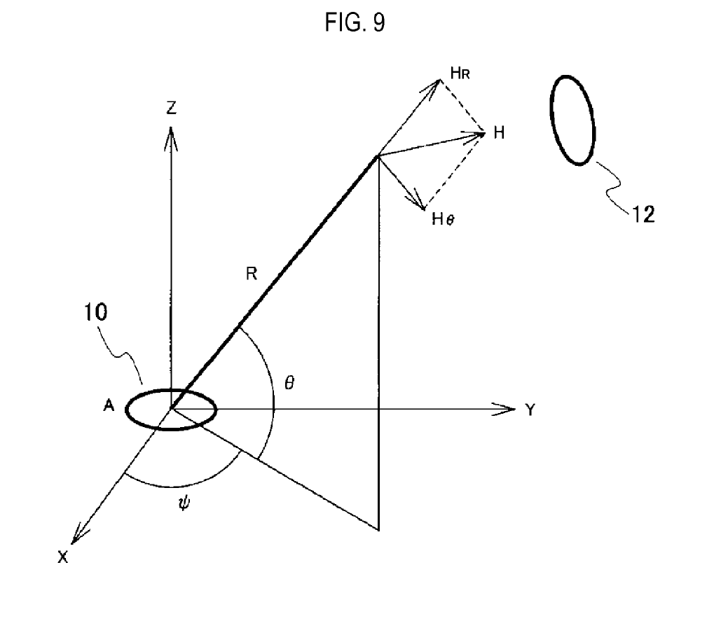

In the remote wireless driving charger 24 according to this embodiment, a vector representation of a magnetic field H induced in the secondary coil 12 by the micro loop A at any position separated by a distance R from the primary coil 10 is as shown in FIG. 9.

As shown in FIG. 9, when the primary coil 10 by the micro loop A is fixed at the origin of the Cartesian coordinate system and the center axis of the embedded primary coil 10 is on a Z axis, maximal sensitivity can be achieved when the center axis of the secondary coil 12 embedded in the portable device is on the Z axis as in the primary coil 10 in either the co-axial arrangement or the co-planar arrangement. In contrast, in a middle position thereof, maximal sensitivity can be achieved when the center axis of the secondary coil 12 is adjusted to a direction of a vector sum H of H_{R} and H_{θ}. Equation 26 expresses the vector sum H of H_{R} and H_{θ}.

$$H = {H}_{R} + {H}_{θ} = \frac{{i}_{1} * ( π {a}^{2} )}{4 π {c}^{2}} [ \begin{matrix}\{ \frac{2 {c}^{2}}{{R}^{3}} + \frac{j 2 ω c}{{R}^{2}} \} * sin ( θ ) + \\ ( - \frac{{c}^{2}}{{R}^{3}} - \frac{j ω c}{{R}^{2}} + \frac{{ω}^{2}}{R} ) * cos ( θ ) *\end{matrix} ] {e}^{- j kR} \qquad [ Equatio n ]$$

This directional combination where the central axis direction of the secondary coil 2 is adjusted to the direction of the primary coil 10 and the direction of the vector sum H of H_{R} and Ho can provide the same power transmission efficiency as the co-axial arrangement and the co-planar arrangement in a limited situation where a user of the portable device makes manual adjustments while watching an indication of efficiency, when the portable device is located at any position in the Cartesian coordinate system at which the origin the remote wireless driving charger is fixed.

### (Omnidirectional Charging)

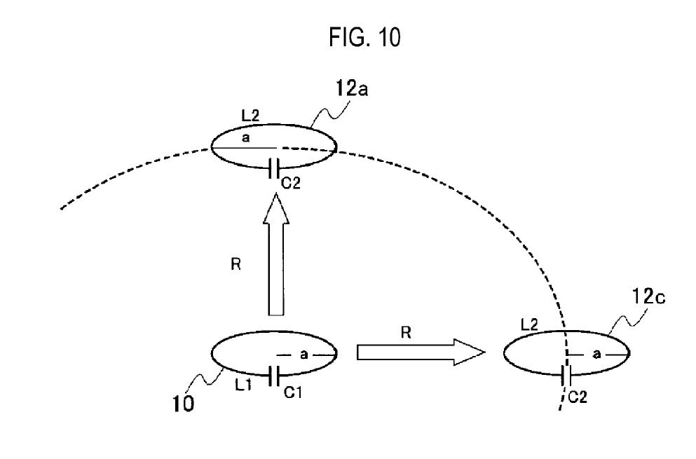

FIG. 10 is a schematic bird's-eye view for explaining omnidirectional charging from the primary coil 10 in the remote wireless driving charger 24 according to this embodiment. In the remote wireless driving charger 24 according to this embodiment, wireless remote charging and driving for the portable device 30 are possible omnidirectionally surrounding the primary coil 10 with no dead angles. The remote wireless driving charger 24 according to this embodiment has relatively uniform sensitivity omnidirectionally.

As shown in FIGS. 9 and 10, the principle of electromagnetic induction for the portable device 30 arranged in any direction is represented by a linear combination of the co-axial arrangement and the co-planar arrangement.

If the power transmission frequency used is 10 MHz, uniform transmission efficiency can be obtained in a sphere having a radius of 3 m surrounding the charger. This indicates that rated power of the charger may not be changed depending on a position of the portable device 30. In the experiment shown in FIG. 21C, efficiency increases as the portable device 30 approaches the charger, which is inconvenient.

In the remote wireless driving charger 24 according to this embodiment, coils of practical dimension may be equipped in all portable devices.

### (Performance of Remote Wireless Driving Charging)

The remote wireless driving charger 24 according to this embodiment can satisfy all of the following requirements for example. Specifically,

(a) It is verified that the portable device 30 can be uniformly charged in a near field to 3 m range of the fixed remote wireless driving charger 24.

(b) It is verified that the portable device 30 can be uniformly charged in any direction (angle) of the fixed remote wireless driving charger 24.

(c) It is verified that the portable device 30 can be charged while the portable device 30 is being used.

(d) It is verified that the fixed remote wireless driving charger 24 can be manufactured at a low cost and can charge several portable devices in turn.

(e) It is verified that the fixed remote wireless driving charger 24 operates with an AC voltage of 100 V to 240 V and has an automatic voltage adjustment function.

(f) It is verified that only authenticated portable devices can be charged.

(g) It is verified that charging by the fixed remote wireless driving charger 24 is not affected by foreign objects and has no interaction with the foreign objects.

(h) It is verified that the fixed remote wireless driving charger 24 has no adverse effect on a human body and is not affected by the human body.

### (Alleviation of Effects by Metal and Foreign Object)

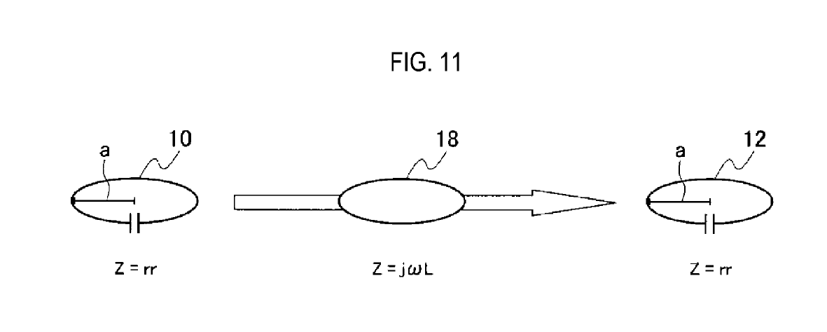

FIG. 11 is a schematic view for explaining an effect of a short ring coil 18 of a foreign object on wireless power transmission in the remote wireless driving charger 24 according to this embodiment. Conventional wired/wireless power transmission was designed with the idea of a cored transformer and a spatial electromagnetic coupling. Therefore, near metal or foreign objects had a significant effect on power transmission as shown in FIG. 11. However, unlike such conventional wired/wireless power transmission, in the remote wireless driving charger 24 according to this embodiment, near metal defined as the short ring coil 18 of the foreign object is merely short-circuited in this inductance L. The primary coil 10 of the remote wireless driving charger 24 and the secondary coil 12 of the portable device 30 are terminated with their radiation loss resistances rr, and, for example, in a coil having a radius a, a ratio of a reactance component ω₀L by its self-inductance L to the radiation loss resistance rr is expressed by Equation 27.

$$\frac{{ω}_{0} L}{rr} = \frac{ln ( 1.4 a / b )}{130 {( a / λ )}^{3}} \qquad [ Equation 27 ]$$

Accordingly, power transmission efficiency with no consideration of copper loss has no relationship with the coil radius a, and the effects of near metal and foreign object decreases in proportion to the coil radius a cubed.

As general knowledge of conventional electromagnetics, if metal lies around a transmitting antenna and a receiving antenna, transmission characteristics are greatly changed to make wireless power transmission virtually impossible. However, such an effect by near metal is minor in the spatial power transmission scheme of the remote wireless driving charger 24 according to this embodiment.

Examples of the effects of foreign objects may include the effect of a metal chassis of the portable device 30, a harmful effect of IH heating of foreign objects, an effect of a human body on transmission characteristics and so on.

Equation 27 corresponds to a Q value of resonance. A larger Q value provides a lesser effect from a foreign object. A large Q value is a very desirable characteristic since it provides high selectivity of transmission frequency bands.

In order to increase a resonant Q value of a general antenna, the dimension of the antenna may be simply shortened. Available power and a S/N ratio of an transceiving antenna has no dependency on the antenna dimension. In addition, a smaller antenna dimension provides a lesser effect from a near metal.

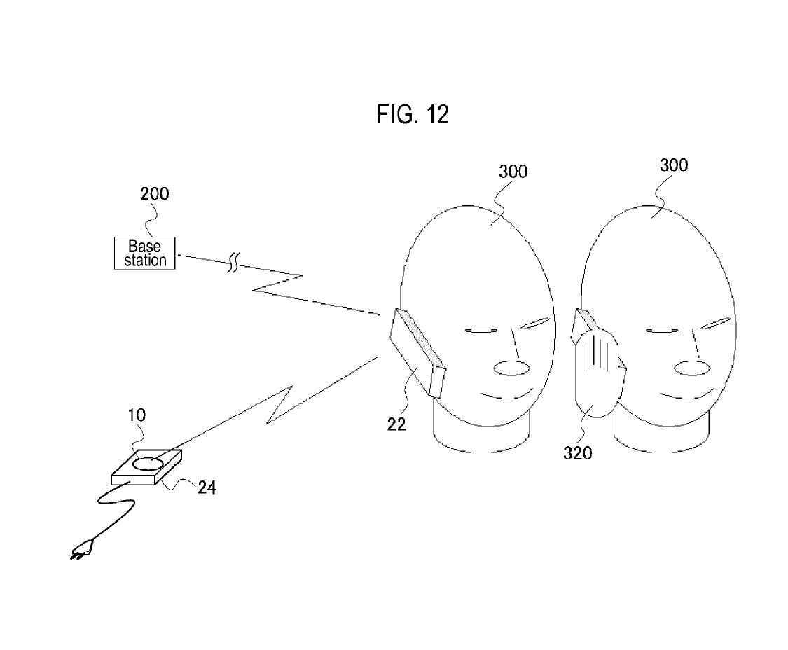

FIG. 12 is a schematic view for explaining the effect of a human body on wireless power transmission in the remote wireless driving charger 24 according to this embodiment. As shown in FIG. 12, a relationship between an upward/downward electromagnetic wave transmitted from a base station 200 (actually a base station antenna) of 850 MHz to a mobile phone 22, an transmitting/receiving antenna of the mobile phone 22 and a human body 300 (including a hand 320) has no change with a relationship between a remote wireless driving charger 24 of 10 MHz, a receiving antenna of the mobile phone 22 and the human body 300 (including the hand 320).

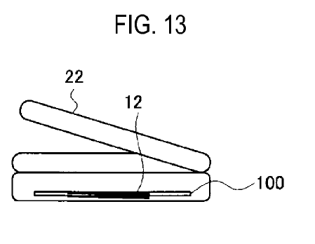

FIG. 13 shows a configuration of the mobile phone 22 remotely and wirelessly charged by the remote wireless driving charger 24 according to this embodiment and a secondary coil 12 embedded in the mobile phone 22.

In the mobile phone 22 remotely and wirelessly charged by the remote wireless driving charger 24 according to this embodiment, as shown in FIG. 13, the secondary coil 12 is constituted by an insulating air core coil formed by a spiral conductive pattern on front and rear surfaces of a printed circuit board 100. The printed circuit board 100 is embedded in the mobile phone 22.

A buried micro resonance antenna of the mobile phone 22 has a narrow band and a large resonant Q value and thus is unlikely to be affected by metal chassis parts of the mobile phone 22. Even if the remote wireless driving charger 24 according to this embodiment is separated by 3 m from the mobile phone 22, near foreign objects and metal have no effect on power transmission characteristics. This is because the primary coil 10 and the secondary coil 12 are coupled with low operation impedance by resonance and mounted parts and the primary coil 10 and the secondary coil 12 are loosely coupled.

In the spatial power transmission scheme by the remote wireless driving charger 24 according to this embodiment, the primary coil 10 and the secondary coil 12 are strongly coupled by resonance of interacting electromagnetic waves, such that the electromagnetic waves does not propagate in a medium such as a vacuum.

An effect of a charging electromagnetic wave of 10 MHz on genes of a human body may be actually negligible as compared to 850 MHz transmission. A higher frequency provides a higher possibility of damage to the shielding effect of base pairs of a double helix structure. Since a double helix structure is temporarily untied in cell division, the shielding effect disappears and cell divisions cannot be protected from electromagnetic waves. However, since an electromagnetic wave has a lower frequency, DNA is entirely electronically floated to eliminate the possibility of a replacement of base pairs.

### (Electromagnetic Principle of Micro Loop)

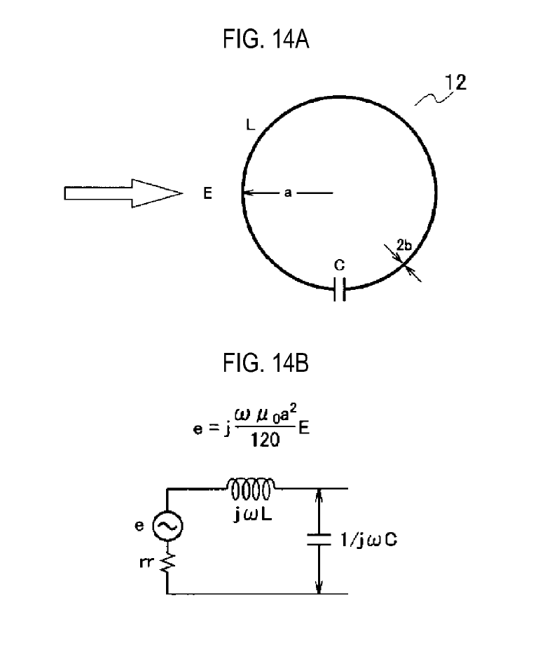

FIGS. 14A and 14B are views for explaining the operation principle of a micro loop antenna having a large Q value and an equivalent circuit diagram thereof, respectively. FIG. 14A shows a shape of a micro loop in which a radiation loss resistance rr involved in mutual inductions between antennas when micro loop antennas are put in an introduced electric field E and an inductance L produced by a light flux delay term of mutual induction between partial currents of a metal conductor are neutralized by a resonance capacitor C. FIG. 14B shows an equivalent circuit of the micro loop. FIG. 14A shows a micro loop antenna as the basic unit of causing all phenomena in the equivalent circuit. The micro loop antenna used herein is terminated with a non-radiation resonance capacitor C. Equations 28 to 31 are well known to professors, researchers and students who engage in antenna engineering, and have before been unquestioned in their meanings.

Equation 28 represents a radiation loss resistance rr of a micro loop antenna. For calculation of the resistance rr, a product of a far field electric field and far field magnetic field of the micro loop antenna is obtained and regarded as power. This product is integrated over a sphere, and a division of the result of this integration by the square of a wave source loop current is defined as a radiation loss resistance rr.

Radiation loss resistance: rr=n²31200π²(a/λ)⁴ [Equation 28]

The reason why the radiation loss resistance rr is proportional to the number of coil winding turns n squared is that a far field electric field and a far field magnetic field are both proportional to a product of the number of winding turns n and the current.

Equation 29 represents a reactance X of the micro loop.

Reactance: X=n²240 π²(a/λ)ln(1.4a/b) [Equation 29]

Mutual induction between partial currents of a micro loop metal conductor represents inductive ability. The reactance X is proportional to the square of the number of winding turns n.

A ratio of the reactance X to the radiation loss resistance rr is a Q value which is also a ratio of a resonance frequency to a bandwidth of a frequency response when the micro loop is short-circuited by a resonant capacitor C. The Q value has no relationship with the number of winding turns n.

The electromagnetic analysis of Faraday shows that an induced voltage of a coil is proportional to a temporal variation of a magnetic flux traversing a loop area and this variation has a direct relationship with an inductance L of the coil. However, Equation 29 has a relationship with a radius b of the coil, and therefore, it can be seen that the induced voltage of the coil has no casual relationship with the inductance L of the coil.

A Q value shown in Equation 30 may be considered to be proportional to the inverse of the micro loop radius a cubed.

$$Q value \text{:} \begin{matrix}Q = X / rr \\ = \frac{{n}^{2} 240 {π}^{2} ( a / λ ) ln ( 1.4 a / b )}{{n}^{2} 31200 {{π}^{2} ( a / λ )}^{4}} \\ = \frac{ln ( 1.4 a / b )}{130 {( a / λ )}^{3}}\end{matrix} \qquad [ Equation 30 ]$$

Equation 31 represents an open terminal voltage V0 when a micro loop of the number of winding turns n is put in an introduced electric field E (or an introduced magnetic field H=E/120η). The open terminal voltage V_{O} refers to a voltage across opened terminals of the micro loop opened to not flow any current therein. Electromagnetics provides the open terminal voltage V_{O} two solutions to provide two possible analyses.

One analysis is obtained from Faraday's law and shows that there is no mutual induction between windings since no current flows, and accordingly, a voltage obtained by a circuital integral of an introduced electric field on the micro loop by n times is the open terminal voltage V0 which is proportional to the number of winding turns n.

Another analysis is an open terminal voltage V_{O} taught by antenna engineering, which is proportional to the number of winding turns n squared which is identical to results obtained by general antenna experiments.

$$Open terminal voltage ( 1 ) \text{:} Faraday ' s law \text{:} \\ {V}_{0} = n * j ω \frac{{μ}_{0}}{120 π} ( π {a}^{2} ) * E \\ Open terminal voltage ( 2 ) \text{:} \\ Antenna engineering \text{:} \\ {V}_{0} = {n}^{2} * j ω \frac{{μ}_{0}}{120 π} ( π {a}^{2} ) * E \qquad [ Equation 31 ]$$

Available power is expressed by Equation 32. The available power has no relationship with the antenna dimension. That is, it can be seen that the idea of taking an energy flux from an antenna section with the idea of energy radiation of Heaviside is incorrect.

$$Available power ( 1 ) \text{:} Faraday ' s law \text{:} \\ \begin{matrix}\frac{{V}_{o}^{2}}{4 rr} = \frac{{n}^{2} * {\{ ω \frac{{μ}_{0}}{120 π} ( π {a}^{2} ) * E \}}^{2}}{4 * {n}^{2} * 31200 {{π}^{2} ( a / λ )}^{4}} \\ = \frac{{λ}^{2} {E}^{2}}{4 \times ( 80 {π}^{2} )}\end{matrix} \\ Available power ( 2 ) \text{:} Antenna engineering \text{:} \\ \begin{matrix}\frac{{V}_{o}^{2}}{4 rr} = \frac{{n}^{4} * {\{ ω \frac{{μ}_{0}}{120 π} ( π {a}^{2} ) * E \}}^{2}}{4 * {n}^{2} * 31200 {{π}^{2} ( a / λ )}^{4}} \\ = \frac{{n}^{2} * {λ}^{2} {E}^{2}}{4 \times ( 80 {π}^{2} )}\end{matrix} \qquad [ Equation 32 ]$$

In handling the available power, a conclusion from Faraday's law greatly differs from a conclusion from antenna engineering. In Faraday's law, the available power has no relationship with the antenna dimension and the number of coil winding turns n. In antenna engineering, the available power has no relationship with the antenna dimension but is proportional to the number of coil winding turns n squared.

With an application of the idea of energy radiation of Heaviside, it may be seen that the available power is proportional to the number of coil winding turns n since energy is taken n times, and, if energy is taken once, the available power has no relationship with the number of winding turns since no energy is left. The experiment shown in FIG. 21C shows that the more number of winding turns provides larger available power and a larger coil also provides larger available power.

A resonance voltage is expressed by Equation 38 and a coil having a smaller radius provides a higher resonance voltage.

$$Resonance voltage ( 2 ) \text{:} \\ \begin{matrix}{V}_{0} \frac{X}{rr} = ω \frac{{μ}_{0}}{120 π} ( π {a}^{2} ) * E * \frac{{n}^{2} {μ}_{0} 2 π C ( a / λ ) ln ( 1.4 a / b )}{31200 {n}^{2} {{π}^{2} ( a / λ )}^{4}} \\ = {π}^{2} {λ}^{6} \frac{ln ( 1.4 a / b )}{65 a} * E\end{matrix} \qquad [ Equation 33 ]$$

In wireless power transmission, in order to bridge-rectify a voltage generated in a secondary coil (receiving coil), a voltage exceeding a diode forward voltage Vf has to be induced. To this end, a loop antenna has to be as small as possible.

### (Application Range of Faraday's Law)

According to Faraday's law, electromagnetic induction appears as an induced voltage which is proportional to temporal differentiation of a magnetic flux traversing a loop. Furthermore, induced current flows to eliminate an introduced magnetic field.

However, as is already apparent within the frame of classical electromagnetics, there is no case where the induced current of the loop eliminates the introduced magnetic field. In addition, it is clear that Faraday's law cannot explain the operation of a dipole.

As Equation 31(2) is widely understood in antenna engineering, considering the experimental fact that the open terminal voltage V_{O} is proportional to the number of winding turns n squared, Faraday's law may be simply considered to be incorrect. However, if no other alternative explanation regarding electromagnetic induction can be presented, our physical world cannot be explained either.

Faraday had the idea that an induction voltage is produced in a loop by temporal differentiation of a magnetic flux and induction current flows through a load resistance connected to the induction voltage. This idea was left unchanged for 100 years. Considering that elimination of an introduced magnetic field belongs to the nature of things as designated by Lents, it is not the induction voltage but the induction current to produce a magnetic field that is to be eliminated. It is essential to produce the induction current as reaction for the introduced magnetic field as action.

However, if a loop is unnaturally opened, induction current flows against this opening. This is referred to as an open terminal voltage V_{O}. According to Thevenin's theorem (or Von-Thevenin's theorem), this voltage is a product of the induction current and a reactance component of the loop. The loop reactance component is proportional to the number of winding turns n squared as expressed by Equation 29. Accordingly, the open terminal voltage V0 is proportional to the number of winding turns n squared of the loop, and cannot be explained by Faraday's law.

This is a more proper understanding and explanation of electromagnetic induction and also explains the operation of a loop and a dipole. Faraday's law cannot but give a contradictory explanation of a loop.

In any case, a magnetic field and an electric field have a relationship of 120η and have the same phase at all times rather than a 90 degree phase difference. That is, the magnetic field and the electric field is the one which is defined with double concepts. In other words, Maxwell's idea and the idea of a pointing vector are meaningless within the frame of classical electromagnetics. If these are excluded, classical electromagnetics are not necessarily discarded and may be utilized because self-contradiction is eliminated. Faraday's law can be used in this form.

### (Charging Profile)

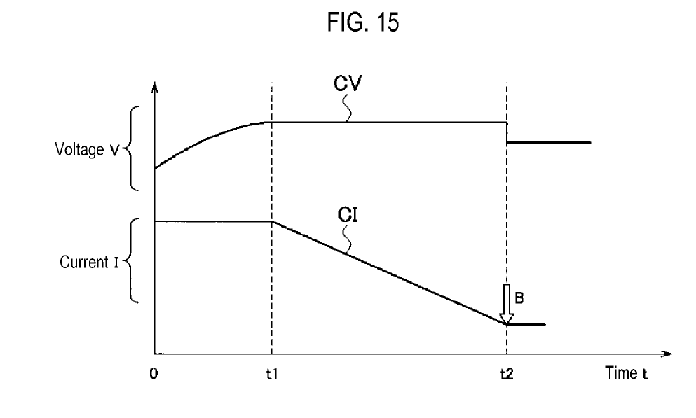

FIG. 15 is a view showing an example of a charging profile of a lithium ion battery embedded in a portable device remotely and wirelessly charged by the remote wireless driving charger 24 according to this embodiment. FIG. 15 shows two curves of a charging voltage CV and charging current CI.

In FIG. 15, an interval of time 0 to t1 is a constant current interval and an interval of time t1 to t2 is a constant voltage interval. At time t2, a current is detected and charging of the lithium ion battery is completed, as indicated by an arrow B, at the same time. The portable device remotely and wirelessly charged by the remote wireless driving charger 24 according to this embodiment has a temperature conservation function, a current detection timer function, a fast charging timer function and an overvoltage protection function.

In the charging profile shown in FIG. 15, charging time is short. For example, charging time for a lithium ion secondary cell of 800 mAh is about 15 minutes. This embodiment uses a fast charging-enabled lithium ion secondary cell. Power consumption of portable devices continues to increase with higher performance. However, the energy capacity of secondary cells is not as simply increased. In this respect, when an infrastructure allowing device users to charge devices safely in a short time anywhere at anytime is prepared, the need to increase energy capacity is alleviated.

Two lithium ion secondary cell packs developed for fast charging were prepared. For one minute and in a contactless manner, one pack was charged with a charging current of 400 mA and the other pack was charged with a charging current of 3 A. A charging current of 400 mA is typical for a current portable phone charging system. Thereafter, each cell pack was connected to a motor-operated model (for example a doll which moves a bicycle) and started to be discharged. The results showed that the motor-operated model stopped after 8 seconds for the pack charged with 400 mA, and continued to operate for 100 seconds for the pack charged with 3 A. Much concern is being voiced about the safety and durability of lithium ion secondary cells due to the high charging current of 3 A. However, this cell originally developed for large-scaled motor driving of electric automobiles has high heat radiation around the cell due to a stack structure employed for an internal electrode. In relation to the deterioration of energy capacity after repeated charging/discharging, it has been considered using improved electrode material to significantly limit deterioration of energy capacity as compared to typical lithium ion secondary cells.

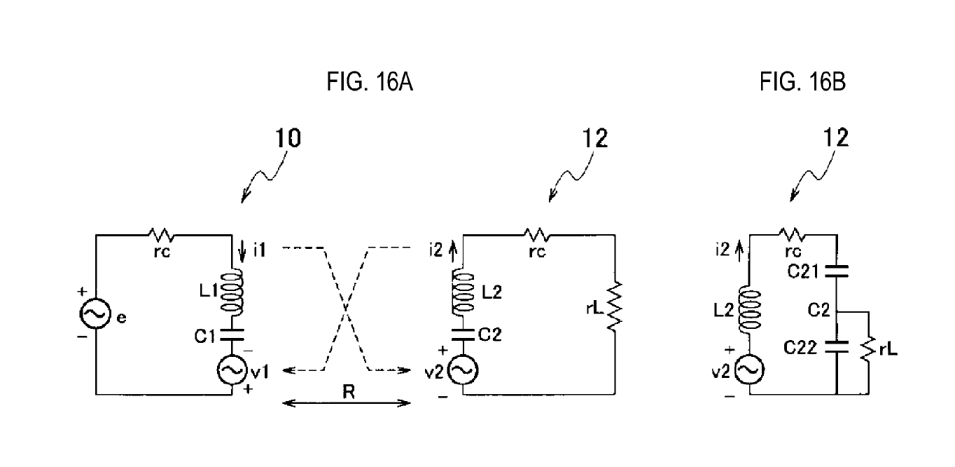

In the remote wireless driving charger 24 according to this embodiment, an equivalent circuit for wireless power transmission in a copper loss limit region (rc>>rr) is shown in FIG. 16A and an equivalent circuit for the portable device 30 is shown in FIG. 16B.

As shown FIG. 16A, the primary coil 10 included in the remote wireless driving charger 24 according to this embodiment is represented by a series circuit including copper loss resistance rc accompanying winding copper loss, an inductance L1, a primary side resonance capacitor C1 and a reverse induction voltage v1. An excitation voltage e is connected to this series circuit to flow a primary side excitation current i1 therethrough.

In addition, as shown in FIG. 16A, the secondary coil 12 embedded in the portable device 30 is represented by a series circuit including equivalent resistance rc accompanying winding copper loss, an inductance L2, a secondary side resonance capacitor C2 and an induction voltage v2. Load resistance rL is connected to this series circuit to flow a secondary side induction current i2 therethrough. Furthermore, as shown in FIG. 16B, the secondary coil 12 is represented by a series circuit including equivalent resistance rc, an inductance L2, a secondary side resonance capacitor C2 and an induction voltage v2. The secondary side resonance capacitor C2 is divided into capacitors C21 and C22 and load resistance rL is connected in parallel to the secondary side resonance capacitor C22. The load resistance rL shown in FIG. 16B corresponds to an input resistance of 4Ω of the portable device 30, as shown in FIG. 3.

The equivalent radius of each of the primary coil 10 and the secondary coil 12 is denoted by a, a power carrier frequency is about 10 MHz, and a wavelength is about 30 m.

(a) The load resistance rL of 4Ω (in average) shown in FIG. 16B can divide the resonance capacitor C2 and can connect a bridge rectification circuit as a load, as shown in FIG. 3.

The load resistance rL shown in FIG. 16B corresponds to an input resistance of 4Ω of the portable device 30, as shown in FIG. 3.

A micro loop1 of the primary coil 10 and a micro loop2 of the secondary coil 12 have their respective resistances rc accompanying winding copper loss and radiation loss may be negligible.

(b) Reactance components of the inductance L1 of the micro loop1 of the primary coil 10 and the inductance L2 of the micro loop2 of the secondary coil 12 are cancelled out by the resonance capacitors C1 and C2.

(c) The micro loop1 of the primary coil 10 is driven by an excitation voltage e to flow the primary side excitation current i1 therethrough.

(d) The secondary side induction current i2 by the primary side excitation current i1 flows through the secondary coil 12 of the micro loop2 having the load resistance rL.

(e) A reverse induction voltage v1 is induced in the micro loop1 of the primary coil 10 by re-radiation of the secondary side induction current i2.

The primary coil 10 and the secondary coil 12 have radiation loss smaller than copper loss. Equation 34 represents the copper loss rc with a volume of cooper of 10 cc considering a skin effect. In this equation, p is copper resistivity, S is a copper sectional area, l is copper length, ω is an angular frequency, μ a is permeability and d is skin depth.

$$Copper loss \text{:} \begin{matrix}rc = {n}^{2} \times ρ \times \frac{l}{S} \\ = {n}^{2} \times ρ \times \frac{2 π a}{{V}_{c} / 2 π a} \\ = {n}^{2} \times 1.7 \times {10}^{- 7} \times \frac{{( 2 π \times 0.06 )}^{2}}{10 \times {10}^{- 6}} \\ = 0.0024 Ω\end{matrix} \\ Skin depth \text{:} d = \sqrt{2 ρ / ω μ} \qquad [ Equation 34 ]$$

In the primary coil 10, Ohm's law of Equation 35 is established since the reactance of the inductance L1 and the reactance of the resonance capacitor C1 are cancelled out.

$$Ohm ' s law of the loop 1 at a resonance point \text{:} \\ {i}_{1} = \frac{( e + {v}_{1} )}{rc} \qquad [ Equation 35 ]$$

In the secondary coil 12, Ohm's law of Equation 36 is established since the reactance of the inductance L2 and the reactance of the resonance capacitor C2 are cancelled out.

$$Ohm ' s law of the loop 2 at a resonance point \text{:} \\ {i}_{2} = \frac{\text{?}}{( rc + \text{?} )} = \frac{\text{?}}{rc ( 1 + \text{?} )} \\ = \frac{\text{?}}{rc} \\ \text{?} \text{indicates text missing or illegible when filed} \qquad [ Equation 36 ]$$

Magnetic field intensity H_{R} on the central axis by the excitation current i1 is expressed by Equation 37.

$$Magnetic field on the central axis \text{:} \\ {H}_{R} = \frac{n \times {i}_{1} * ( π {a}^{2} ) }{2 π} \{ \frac{jk}{{R}^{2}} + \frac{1}{{R}^{3}} \} * {e}^{- j kR} \qquad [ Equation 37 ]$$

An induction voltage v2 of the secondary coil 12 by the excitation current i1 is expressed by Equation 38.

$$Induction voltage \text{:} \\ \begin{matrix}{v}_{2} = j ω {μ}_{0} {H}_{R} * n ( π {a}^{2} ) \\ = \frac{j ω {μ}_{0} {i}_{1} * {n ( π {a}^{2} )}^{2}}{2 π} \{ \frac{jk}{{R}^{2}} + \frac{1}{{R}^{3}} \} * {e}^{- j kR}\end{matrix} \\ {μ}_{0} = 4 π \times {10}^{- 7} \qquad [ Equation 38 ]$$

Ohm's law by the induction current i2 in the secondary coil 12 is expressed by Equation 39.

$$\begin{matrix} Induction current \text{:} \\ \begin{matrix} {i}_{2} = \frac{{v}_{2}}{rc ( 1 + \text{?} )} \\ = \frac{j ω {μ}_{0} {i}_{1} * n ( π {a}^{2} )}{2 π * rc ( 1 + \text{?} )} \{ \frac{1}{{R}^{3}} + \frac{jk}{{R}^{2}} \} {e}^{- j kR} \\ = \frac{60 {i}_{1} * {n ( π {a}^{2} )}^{2} {( 2 π )}^{4}}{{λ}^{4} * rc ( 1 + \text{?} )} \{ {j ( \frac{λ}{2 π R} )}^{3} - {( \frac{λ}{2 π R} )}^{2} \} * {e}^{- j kR}\end{matrix} & [ Equation 39 ] \\ \text{?} \text{indicates text missing or illegible when filed} & \end{matrix}$$

Ohm's law by the excitation current i1 in the primary coil 10 is expressed by Equation 40.

$$\begin{matrix} Excitation current \text{:} \\ \begin{matrix}rc * {i}_{1} = ( e + {v}_{1} ) \\ = ( e + \frac{j ω {μ}_{0} {i}_{2} * {n ( π {a}^{2} )}^{2}}{2 π} \{ \frac{1}{{R}^{3}} + \frac{jk}{{R}^{2}} \} * {e}^{- j kR} ) \\ = e + \frac{j ω {μ}_{0} [ \frac{60 {i}_{1} * n {( π {a}^{2} )}^{2} {( 2 π )}^{4}}{{λ}^{4} rc ( 1 + \text{?} )} \{ \begin{matrix}j {( \frac{λ}{2 π R} )}^{3} - \\ {( \frac{λ}{2 π R} )}^{2}\end{matrix} \} * {e}^{- j kR} ] * {n ( π {a}^{2} )}^{2}}{2 π} \\ \{ \frac{1}{{R}^{3}} + \frac{jk}{{R}^{2}} \} * {e}^{- j kR} \\ = e - \frac{3600 {{i}_{1} ( 2 π )}^{8} {\{ \begin{matrix}{( \frac{λ}{2 π R} )}^{3} + \\ {j ( \frac{λ}{2 π R} )}^{2}\end{matrix} \}}^{2} * {{n}^{2} ( π {a}^{2} )}^{4}}{{λ}^{8} rc ( 1 + \text{?} )} * {e}^{- j 2 kR}\end{matrix} & [ Equation 40 ] \\ \text{?} \text{indicates text missing or illegible when filed} & \end{matrix}$$

Accordingly, Equation 41 is obtained.

$$∴ {i}_{1} [ rc + \frac{3600 {( 2 π )}^{8} {\{ \begin{matrix}{( \frac{λ}{2 π R} )}^{3} + \\ {j ( \frac{λ}{2 π R} )}^{2}\end{matrix} \}}^{2} * {{n}^{2} ( π {a}^{2} )}^{4}}{{λ}^{8} rc ( 1 + \text{?} )} * {e}^{- j 2 kR} ] = e \\ \text{?} \text{indicates text missing or illegible when filed} \qquad [ Equation 41 ]$$

Input power Pᵢₙ to the primary coil 10 is expressed by Equation 42 with a product of the in-phase components of a voltage and a current.

$$Input power \text{:} \\ \begin{matrix}{P}_{in} = Re [ {i}_{1} \times e ] \\ = {\vert {i}_{1} \vert}^{2} \times [ rc + Re [ \frac{\begin{matrix}3600 {( 2 π )}^{8} {\{ \begin{matrix}{( \frac{λ}{2 π R} )}^{3} + \\ {j ( \frac{λ}{2 π R} )}^{2}\end{matrix} \}}^{2} * \\ {{n}^{2} ( π {a}^{2} )}^{4}\end{matrix}}{{λ}^{8} rc ( 1 + \text{?} )} * {e}^{- j 2 kR} ] ]\end{matrix} \\ \text{?} \text{indicates text missing or illegible when filed} \qquad [ Equation 42 ]$$

On the other hand, power Pₒᵤₜ transmitted to the load resistance is expressed by Equation 43.

Load power: Pₒᵤₜ=|i₂|²×rc*m_{L} [Equation 43]

Accordingly, wireless power transmission efficiency η in the copper loss limit region (rc>>rr) is expressed by Equation 44.

$$\begin{matrix}\begin{matrix}η = \frac{{P}_{out}}{{P}_{in}} = \frac{{\vert {i}_{2} \vert}^{2} \times rc * \text{?}}{Re [ {i}_{1} \times e ]} \\ = \frac{{\vert {i}_{1} \vert}^{2} {\{ \frac{60 {n ( π {a}^{2} )}^{2} {( 2 π )}^{4}}{{λ}^{4} * rc ( 1 + \text{?} )} \}}^{2} rc * \text{?} {\vert \{ \begin{matrix}{j ( \frac{λ}{2 π R} )}^{3} - \\ {( \frac{λ}{2 π R} )}^{2 \}}\end{matrix} \} * {e}^{- j kR} \vert}^{2}}{{\vert {i}_{1} \vert}^{2} \times [ rc + Re [ \frac{\begin{matrix}3600 {n}^{2} {{π}^{8} ( \frac{2 π a}{λ} )}^{8} \\ {\{ \begin{matrix}{( \frac{λ}{2 π R} )}^{3} + \\ {j ( \frac{λ}{2 π R} )}^{2}\end{matrix} \}}^{2}\end{matrix}}{rc ( 1 + \text{?} )} * {e}^{- j kR} ] ]} \\ = \frac{{\{ \frac{60 {n ( π {a}^{2} )}^{2} {( 2 π )}^{4}}{{λ}^{4} * rc ( 1 + \text{?} )} \}}^{2} \text{?} {\vert \{ \begin{matrix}{j ( \frac{λ}{2 π R} )}^{3} - \\ {( \frac{λ}{2 π R} )}^{2}\end{matrix} \} \vert}^{2}}{[ 1 + Re [ \frac{\begin{matrix}3600 {n}^{2} {{π}^{8} ( \frac{2 π a}{λ} )}^{8} \\ {\{ \begin{matrix}{( \frac{λ}{2 π R} )}^{3} + \\ {j ( \frac{λ}{2 π R} )}^{2}\end{matrix} \}}^{2} *\end{matrix}}{rc ( 1 + \text{?} )} * {e}^{- j kR} ] ]} \\ = \frac{\text{?} * {\vert \{ {j ( \frac{λ}{2 π R} )}^{3} - {( \frac{λ}{2 π R} )}^{2} \} \vert}^{2}}{\begin{matrix}{( 1 + \text{?} )}^{2} {\{ \frac{rc * {λ}^{4}}{960 {π}^{8} {na}^{4}} \}}^{2} + ( 1 + \text{?} ) * \\ Re [ {\{ {( \frac{λ}{2 π R} )}^{3} + {j ( \frac{λ}{2 π R} )}^{2} \}}^{2} * {e}^{- j kR} ]\end{matrix}}\end{matrix} & [ Equation 44 ] \\ \text{?} \text{indicates text missing or illegible when filed} & \end{matrix}$$

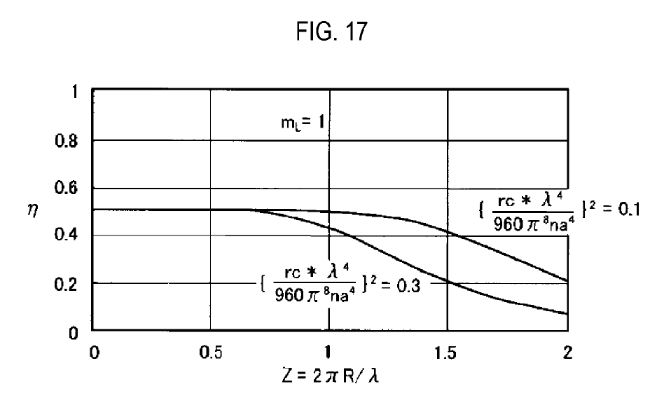

FIG. 17 is a view showing a relationship between a distance R and a power transmission efficiency η in a co-axial arrangement in a copper loss limit region (rc>>rr) in the remote wireless driving charger 24 according to this embodiment. When the equivalent radius a of a coil at a power carrier frequency of 10 MHz is typically 6 cm, it can be seen that an efficiency of about 50% can be obtained in a near field to 3 m range.

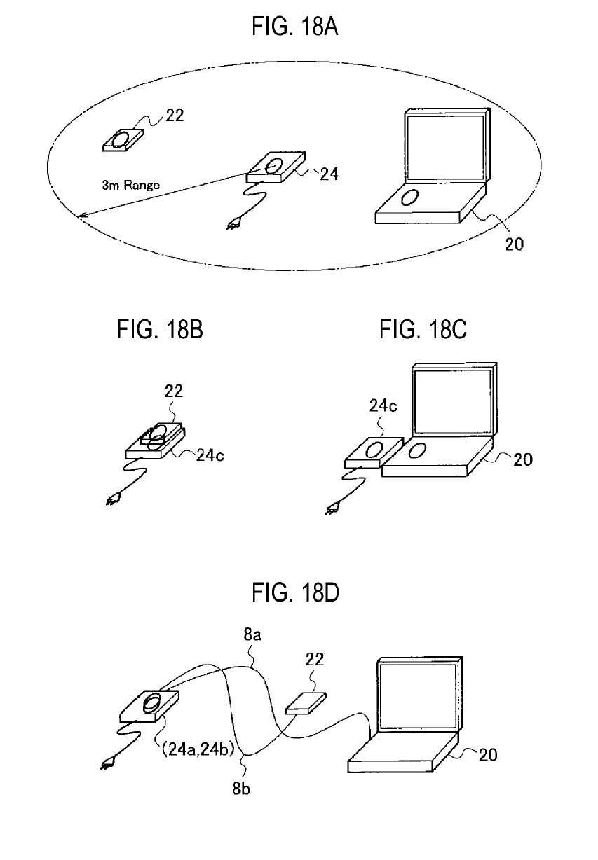

FIG. 18A shows, as a common portable device charging technique, an embodiment capable of wirelessly charging and driving a mobile phone 22 and a notebook computer 20 omnidirectionally within a spherical surface having a radius of Ro using the remote wireless driving charger 24 according to this embodiment. In the embodiment of FIG. 18A, the mobile phone 22 and the notebook computer 20 can be omnidirectionally charged and driven in the spherical surface having the radius of Ro=about 3 m. Efficiency is about 50%.

FIGS. 18B and 18C show, as a common portable device charging technique, comparative examples capable of wirelessly charging and driving the mobile phone 22 and the notebook computer 20 in a near field using a near field wireless charging AC adaptor 24c, respectively. In the comparative examples of FIGS. 18B and 18C, the mobile phone 22 and the notebook computer 20 can be wirelessly charged and driven in the near field and efficiency is 70% or more.

FIG. 18D is a schematic view of a comparative example of charging AC adaptors 24a and 24b capable of charging and driving the mobile phone 22 and the notebook computer 20 through cord connection using a dedicated cable 8a, a dedicated connector 8b or the like. In the charging AC adaptors 24a and 24b of this comparative example, efficiency of 80% or more can be achieved.

The remote wireless driving charger according to this embodiment assumes the following application range, for example, without being limited thereto.

(a) A portable device is remotely and wirelessly charged by the remote wireless driving charger in a near field to about 3 m range indoors and outdoors.

(b) The portable device should be adjusted to a direction providing maximal sensitivity although it may be at any position relative to the fixed remote wireless driving charger.

(c) The portable device has a main purpose of direct wireless remote driving and a secondary purpose of charging a secondary cell. Accordingly, there is no need of impractical high densification of a charging battery, so that firing and explosion accidents can be avoided.

(d) Examples of the portable device include a mobile phone, a cordless telephone, a PDA, a portable game machine, a portable music player, a portable video player, a digital still/movie camera, an electric shaver, an electric toothbrush and so on which are individualized for a common remote wireless driving charger.

The present disclosure can provide a remote wireless driving charger using a shortwave to UHF band carrier, which is capable of wirelessly and remotely charging and driving portable devices with an efficiency of 50% or more without being affected by foreign objects, even if the portable devices lie in any position in a solid angle.

### Other Embodiments

Although the present disclosure has been described by way of an embodiment, the description and the drawings, both of which are parts of the specification, are not intended to limit the present disclosure. It is apparent to those skilled in the art that the present disclosure may be modified and changed in different forms of embodiments, examples and operation techniques.

According to the present disclosure in some embodiments, it is possible to provide a remote wireless driving charger using a shortwave to UHF band carrier, which is capable of wirelessly and remotely charging and driving portable devices with an efficiency of 50% or more without being affected by foreign objects, even if the portable devices lie in any position in a solid angle.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

The remote wireless driving charger according to the above embodiments can be applied to all portable devices in that they can be wirelessly driven and charged with the common remote wireless driving charger which is fixed at homes/schools/offices without being carried with the portable devices, irrespective of the kind and charging profiles of batteries driving the portable devices.

What is claimed is:

1. A remote wireless driving charger comprising:
a transmitter;
a primary side resonance capacitor connected to the transmitter;
a primary coil which is connected to the primary side resonance capacitor and is tuned to be resonant with the primary side resonance capacitor in a predetermined power carrier frequency band;
a secondary coil embedded in a portable device; and
a secondary side resonance capacitor which is connected to the secondary coil and is tuned to be resonant with the secondary coil in the predetermined power carrier frequency band,
wherein radioactive inductance components as micro loops of the primary coil and the secondary coil are cancelled out by the non-radioactive primary side resonance capacitor and secondary side resonance capacitor through an electromagnetic coupling between the primary coil and the secondary coil, and the portable device is remotely and wirelessly charged.

2. The remote wireless driving charger of claim 1, further comprising:
a magnetic core transformer connected to an AC terminal;
a first diode bridge connected to the magnetic core transformer; and
a stabilization circuit connected to the first diode bridge,
wherein the transmitter is connected to the stabilization circuit.

3. The remote wireless driving charger of claim 1, wherein the predetermined power carrier frequency band is a shortwave to UHF band of 3 MHz to 3 GHz.

4. The remote wireless driving charger of claim 1, wherein both of the primary coil and the secondary coil have an equivalent radius of 2 cm to 10 cm, a number of winding turns of 1 to 10 and a copper volume of 1 cc to 10 cc.

5. The remote wireless driving charger of claim 1, wherein a Q value of self-resonance defined by a ratio of reactance of the primary coil and the secondary coil to radiation loss resistance is set to 50 or more.

6. The remote wireless driving charger of claim 1, wherein an indication of a power transmission efficiency calculated in the portable device is provided and the portable device is in a near field to 3 m range from the fixed remote wireless driving charger and adjusts the secondary coil to a direction giving maximal sensitivity at any position, and wireless power driving and charging is performed while using the portable device.

7. The remote wireless driving charger of claim 1, wherein, in a wireless power transmission in a near field to 3 m range, when a direction of the secondary coil relative to the primary coil is adjusted to provide a maximal receiving voltage, fast charging of 5 to 10 minutes is performed in the portable device and a sign of fast charging is indicated by an LED indicator connected to the transmitter.

8. The remote wireless driving charger of claim 1, wherein the transmitter controls tuning by detecting a resonance frequency of the primary coil and a resonance frequency of the secondary coil, respectively.

9. The remote wireless driving charger of claim 2, wherein a voltage obtained by dropping an AC voltage of the AC terminal through the magnetic core transformer and then bridge-rectifying the dropped AC voltage by means of the first diode bridge is converted into a low AC voltage in the stabilization circuit, which is then automatically adjusted to correspond to an AC input of the transmitter.

10. The remote wireless driving charger of claim 1, wherein the portable device transmits feedback information including detection information of an input voltage wirelessly and the remote wireless driving charger receives the feedback information and transmits the received feedback information to the transmitter.

11. The remote wireless driving charger of claim 1, wherein the portable device includes a second diode bridge connected to the secondary coil, a receiver connected to the second diode bridge, and a charging profile IC connected to the receiver, and transmits feedback information including detection information of the input voltage from the charging profile IC to the transmitter wirelessly.

12. The remote wireless driving charger of claim 11, wherein interactive communication is conducted between the transmitter and the charging profile IC.
